(19) United States
(12) Patent Application Publication
(10) Pub. No.: US 2026/0316375 A1
(43) Pub. Date: Oct. 15, 2026

(54) THIOUREA POLYMER NETWORKS COMPRISING THIOETHER CROSSLINKS AND PROCESS OF MAKING AND USING SAME

(71) Applicant: Government of the United States as represented by the Secretary of the Air Force, Wright-Patterson AFB, OH (US)

(72) Inventors: Ashley Robinson, Lancaster, CA (US); Levi Moore, Lancaster, CA (US); Kamran Ghiassi, Palmdale, CA (US); Maren Summers, Lancaster, CA (US); David Phan, Lancaster, CA (US)

(21) Appl. No.: 19/636,045

(22) Filed: Apr. 1, 2026

Related U.S. Application Data
(60) Provisional application No. 63/785,244, filed on Apr. 8, 2025.

(51) Int. Cl. B29C 64/106; B29C 71/02; B29K 71/00; B29K 105/24; B33Y 10/00; B33Y 40/20; B33Y 70/10; C08G 85/00

(52) U.S. Cl. CPC B29C 64/106; B29C 71/02; B33Y 10/00; B33Y 40/20; B33Y 70/10; C08G 85/004; B29K 2071/00; B29K 2105/24; C08G 2650/04

(57) ABSTRACT

The present invention relates to articles comprising thiourea polymer networks having thioether crosslinks, alkene-functionalized thiourea polymers, liquid resins comprising such alkene-functionalized thiourea polymers and process of making and using such alkene-functionalized thiourea polymers, liquid resins and articles. The aforementioned liquid resin is converted to an article by UV casting, thermal casting, VP and/or direct ink writing processes. The 3D article has the desired mechanical properties. In one aspect, such mechanical properties include having a maximum stress of at least 100 psi and at least 100% strain at break. In addition to the desired mechanical properties, Applicants' 3D articles can be self-healing and/or reprocessable.

### CROSS-REFERENCE TO RELATED APPLICATIONS

This application claims the benefit of and priority to U.S. Provisional Application Ser. No. 63/785,244, entitled “Thiourea Polymer Networks Comprising Thioether Crosslinks and Process of Making and Using Same,” filed on Apr. 8, 2025, the entirety of which is incorporated by reference herein.

This application is related to U.S. patent application Ser. No. 19/635,941, filed on even date herewith by Robinson et al., and entitled “Thiourea Polymer Networks Comprising Thioether Crosslinks and Process of Making and Using Same” (AFD-2643A), the entirety of which is incorporated by reference herein.

### RIGHTS OF THE GOVERNMENT

The invention described herein may be manufactured and used by or for the Government of the United States for all governmental purposes without the payment of any royalty.

### FIELD OF THE INVENTION

The present invention relates to articles comprising thiourea polymer networks having thioether crosslinks, alkene-functionalized thiourea polymers, liquid resins comprising such alkene-functionalized thiourea polymers and process of making and using such alkene-functionalized thiourea polymers, liquid resins, and articles.

### BACKGROUND OF THE INVENTION

Processes such as casting and 3D printing are used to make articles. For example, 3-dimensional (3D) printing makes three-dimensional objects by building up material, based upon design data provided from a computer aided design (CAD) system. One technique is to deposit a resolidifiable material in a predetermined pattern, according to design data provided from a CAD system, with the build-up of multiple layers forming the object. The resolidifiable materials can be either in the form of filaments, powdered resins or liquid resins. When liquid resins are used as a raw material, the additive manufacturing processes that are used include direct ink writing and vat photopolymerization (VP)—examples of VP include but are not limited to techniques such as stereolithography (SLA), digital light processing (DLP), masked stereolithography (MSLA), and liquid crystal display (LCD) 3D printing. Unfortunately, the current materials used in the vat photopolymerization process and direct ink writing (DIW) process as well as the processing conditions for same require multiple complex formulations having different chemistries and post processing to yield a 3D article that has the desired mechanical properties.

Applicants recognized that the source of the aforementioned problem was the lack of control of the polymer network topology of the 3D article. Applicants solved the aforementioned problem by developing an alkene-functionalized thiourea polymer, liquid resin that comprises said alkene-functionalized thiourea polymer and a multifunctional thiol. Applicants' liquid resin allows the skilled artisan to control the topology of the polymer network of a 3D article as it controls the quantity and location of the reactive crosslinking sites of 3D article's polymer network. Applicants disclose herein the aforementioned liquid resin and UV casting, thermal casting, VP and direct ink writing processes for converting such liquid resin into a 3D article having the desired mechanical properties. In one aspect, such mechanical properties include having a maximum stress of at least 100 psi and at least 100% strain at break. In addition to the desired mechanical properties, Applicants' 3D articles can be self-healing and/or reprocessable. While not being bound by theory, Applicants believe that such self-healing and/or reprocessability is due to the dynamic covalent thioureas in the cured network that enables bond exchange and bond reformation after mechanical damage. Furthermore, Applicants' additive manufacturing process works across the breadth of low temperature applications and yet still results in articles that are robust, have readily tunable properties compared to currently produced articles, and exhibit said self-healing and reprocessability.

### SUMMARY OF THE INVENTION

The present invention relates to articles comprising thiourea polymer networks having thioether crosslinks, alkene-functionalized thiourea polymers, liquid resins comprising such alkene-functionalized thiourea polymers and process of making and using such alkene-functionalized thiourea polymers, liquid resins and articles. The aforementioned liquid resin is converted to an article by UV casting, thermal casting, VP and/or direct ink writing processes. The 3D article has the desired mechanical properties. In one aspect, such mechanical properties include having a maximum stress of at least 100 psi and at least 100% strain at break. In addition to the desired mechanical properties, Applicants' 3D articles can be self-healing and/or reprocessable.

### BRIEF DESCRIPTION OF THE DRAWINGS

The accompanying drawings, which are incorporated in and constitute a part of this specification, illustrate embodiments of the invention and, together with the summary given above, and the detailed description given below, serve to explain the invention.

FIG. 1 is a process diagram depicting a process for producing a 3D printable resin, 3D printing with such resin to form a 3D article and curing such article.

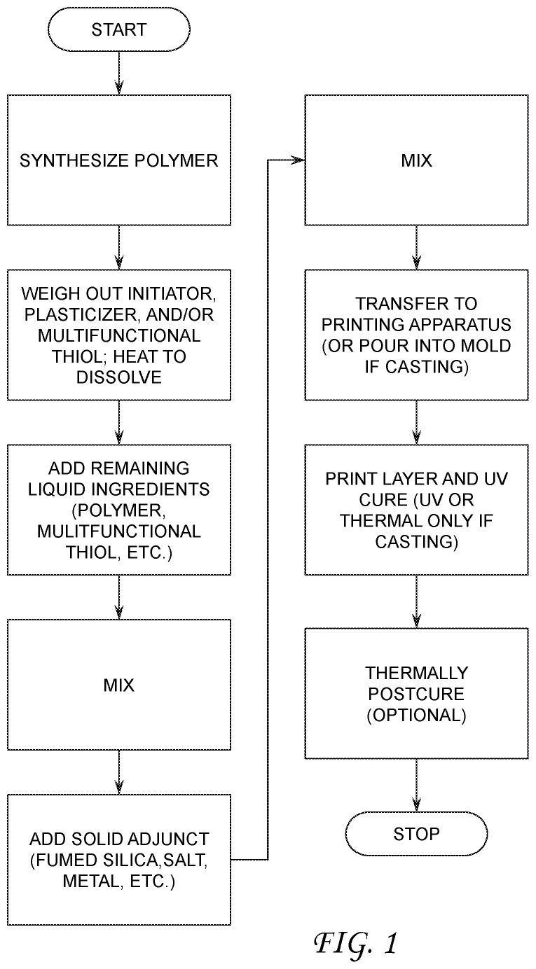

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about,” “approximately,” or the like, when accompanying a numerical value, are to be construed as indicating a deviation as would be appreciated by one of ordinary skill in the art to operate satisfactorily for an intended purpose.

As used herein, the words “and/or” means, when referring to embodiments (for example an embodiment having elements A and/or B) that the embodiment may have element A alone, element B alone, or elements A and B taken together.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Thiourea Terminated Polymer and Processes of Making and Using Same

In this paragraph Applicants disclose a thiourea terminated polymer, said thiourea terminated polymer comprising allyl groups, said thiourea terminated polymer having Structure 1 or Structure 2 below

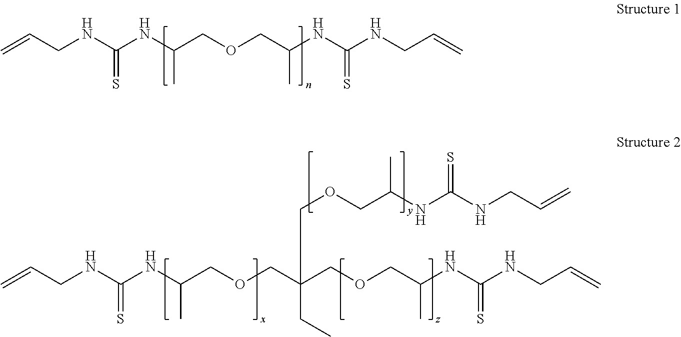

wherein: for Structure 1 the indice n is an integer from about 1 to about 430, preferably said indice n is an integer from about 2 to about 170, more preferably said indice n is an integer from about 6 to about 33; and for Structure 2 the sum of indices x, y and z is an integer from about 3 to about 170, with the proviso that each of x, y and z are at least 1, preferably the sum of indices x, y and z is an integer from about 4 to about 120 with the proviso that each of x, y and z are at least 1, more preferably the sum of indices x, y and z is an integer from about 5 to about 84 with the proviso that each of x, y and z are at least 1.

In this paragraph Applicants disclose a process of making a thiourea terminated polymer comprising heating a mixture, preferably said mixture is homogeneous, that comprises a multifunctional amine-terminated polymer and allyl isothiocyanate, said mixture comprising said multifunctional amine-terminated polymer and allyl isothiocyanate in a amine reactive site to isothiocyanate reactive site ratio of 0.95:1 to 1.05:1, preferably said amine reactive site to isothiocyanate reactive site ratio is 0.98:1 to 1.02:1, more preferably said amine reactive site to isothiocyanate reactive site ratio is 0.99:1 to 1.01:1, most preferably said amine reactive site to isothiocyanate reactive site ratio is 1:1; to a temperature from about 80° C. to about 140° C., preferably said mixture is heated to a temperature from about 80° C. to about 120° C., more preferably said mixture is heated to a temperature from about 80° C. to about 110° C., most preferably said mixture is heated to a temperature from about 80° C. to about 100° C. for at least 1 hour, preferably for from about 1 hour to about 16 hours, more preferably for from about 1 hour to about 4 hours, most preferably for from about 1 hour to about 2 hours; to form a thiourea terminated polymer, preferably said thiourea terminated polymer has one of the following structures:

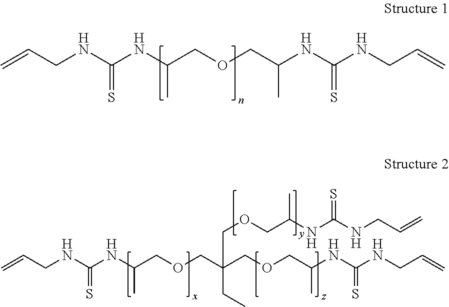

wherein: for Structure 1 the indice n is an integer from about 1 to about 430, preferably said indice n is an integer from about 2 to about 170, more preferably said indice n is an integer from about 6 to about 33; and for Structure 2 the sum of indices x, y and z is an integer from about 3 to about 170, with the proviso that each of x, y and z are at least 1, preferably the sum of indices x, y and z is an integer from about 4 to about 120 with the proviso that each of x, y and z are at least 1, more preferably the sum of indices x, y and z is an integer from about 5 to about 84 with the proviso that each of x, y and z are at least 1.

In this paragraph Applicants disclose the process of the previous paragraph wherein said multifunctional amine-terminated polymer comprises a trifunctional amine-terminated poly(propylene oxide) and/or difunctional amine-terminated poly(propylene oxide), preferably said trifunctional amine-terminated poly(propylene oxide) has a number average molecular weight of from about 300 Da to about 10,000 Da, more preferably said trifunctional amine-terminated poly(propylene oxide) has a number average molecular weight of from about 350 Da to about 7,000 Da, most preferably said trifunctional amine-terminated poly(propylene oxide) has a number average molecular weight of from about 400 Da to about 5,000 Da and preferably said difunctional amine-terminated poly(propylene oxide) has a number average molecular weight of from about 130 Da to about 25,000 Da, more preferably said difunctional amine-terminated poly(propylene oxide) has a number average molecular weight of from about 200 Da to about 10,000 Da, most preferably said difunctional amine-terminated poly(propylene oxide) has a number average molecular weight of from about 400 Da to about 2,000 Da.

In this paragraph Applicants disclose the process of the previous two paragraphs wherein after said heating vacuum is applied to said mixture, preferably said vacuum that is applied to said mixture is below 75 millitorr, more preferably said vacuum that is applied to said mixture is from about 10 millitorr to about 50 millitorr, most preferably said vacuum that is applied to said mixture is from about 20 millitorr to about 50 millitorr.

In this paragraph Applicants disclose a process of making a thiourea terminated polymer comprising: heating a mixture, preferably said mixture is homogeneous, that comprises a solvent, a multifunctional amine-terminated polymer and allyl isothiocyanate, said mixture comprising said multifunctional amine-terminated polymer and allyl isothiocyanate in a amine reactive site to isothiocyanate reactive site ratio of that is greater than 1 to 1, preferably said amine reactive site to isothiocyanate reactive site ratio is 1.2 to 1; to a temperature from about 80° C. to about 140° C., preferably said mixture is heated to a temperature from about 80° C. to about 120° C., more preferably said mixture is heated to a temperature from about 80° C. to about 110° C., most preferably said mixture is heated to a temperature from about 80° C. to about 100° C. for at least 1 hour, preferably for from about 1 hour to about 16 hours, more preferably for from about 1 hour to about 4 hours, most for from about 1 hour to about 2 hours; to form a thiourea terminated polymer, preferably said thiourea terminated polymer has one of the following structures:

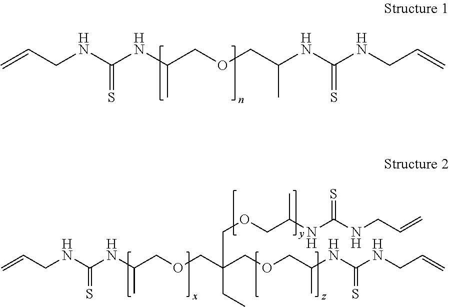

wherein
for Structure 1 the indice n is an integer from about 1 to about 430, preferably said indice n is an integer from about 2 to about 170, more preferably said indice n is an integer from about 6 to about 33; and
for Structure 2 the sum of indices x, y and z is an integer from about 3 to about 170, with the proviso that each of x, y and z are at least 1, preferably the sum of indices x, y and z is an integer from about 4 to about 120 with the proviso that each of x, y and z are at least 1, more preferably the sum of indices x, y and z is an integer from about 5 to about 84 with the proviso that each of x, y and z are at least 1; adding a hydrophilic amine to said mixture to form a hydrophilic thiourea; extracting said hydrophilic thiourea from said mixture using water; and removing said solvent from said mixture.

In this paragraph Applicants disclose resin comprising: a thiourea terminated polymer according to Structure 1 and/or Structure 2 of the first paragraph of this section of this specification titled “Thiourea Terminated Polymer and Processes of Making and Using Same”; a multifunctional thiol crosslinker, preferably said multifunctional thiol crosslinker is selected from the group consisting of 1,4-butanedithiol; 4,5-bis(mercaptomethyl)-o-xylene; 1,4-benzenedithiol; 4,4′-biphenyldithiol; 1,3,5-benzenetrithiol; 2,3-butanedithiol; 1,3-benzenedithiol; 1,10-decanedithiol; DL-dithiothreitol; dithioerythritol; 1,5-dimercaptonaphthalene; 3,6-dioxa-1,8-octanedithiol; 3,7-dithia-1,9-nonanedithiol; 1,2-ethanedithiol; 1,6-hexanedithiol; bis(2-mercaptoethyl) sulfide; 1,8-octanedithiol; 1,9-nonanedithiol 1,3-propanedithiol; 1,5-pentanedithiol; 4,4′-thiobisbenzenethiol; tetra(ethylene glycol) dithiol; 1,11-undecanedithiol; hexa(ethylene glycol) dithiol; 1,16-hexadecanedithiol; a thiol-functional polymer; ethylene bis(thioglycolate); trimethylolpropane tris(thioglycolate); ethylene glycol bis(3-mercaptopropionate); trimethylolpropane tris(3-mercaptopropionate); pentaerythritol tetrakis(3-mercaptopropionate); pentaerythritol tetrakis(mercaptoacetate) and mixtures thereof, more preferably said multifunctional thiol crosslinker is selected from the group consisting of trimethylolpropane tris(3-mercaptopropionate); pentaerythritol tetrakis(3-mercaptopropionate); ethylene glycol bis(3-mercaptopropionate); 3,6-dioxa-1,8-octanedithiol and mixtures thereof; and a radical initiator, preferably said radical initiator is a UV initiator and/or thermal initiator, preferably said UV initiator is selected from the group consisting of acetophenone; anisoin; anthraquinone; (benzene)tricarbonylchromium; benzil; benzoin; benzoin ethyl ether; benzoin isobutyl ether; benzoin methyl ether; benzophenone; 1-hydroxycyclohexyl phenyl ketone; 3,3′,4,4′-benzophenonetetracarboxylic dianhydride; 4-benzoylbiphenyl; 2-benzyl-2-(dimethylamino)-4′-morpholinobutyrophenone; 4,4′-bis(diethylamino)benzophenone; 4,4′-bis(dimethylamino)benzophenone; camphorquinone; 2-chlorothioxanthen-9-one; (cumene)cyclopentadienyliron(II) hexafluorophosphate; dibenzosuberenone; 2,2-diethoxyacetophenone; 4,4′-dihydroxybenzophenone; 2,2-dimethoxy-2-phenylacetophenone; 4-(dimethylamino)benzophenone; 4,4′-dimethylbenzil; 2,5-dimethylbenzophenone; 3,4-dimethylbenzophenone; diphenyl(2,4,6-trimethylbenzoyl)phosphine oxide; 2-hydroxy-2-methylpropiophenone; 4′-ethoxyacetophenone; 2-ethylanthraquinone; ferrocene; 3′-hydroxyacetophenone; 4′-hydroxyacetophenone; 3-hydroxybenzophenone; 4-hydroxybenzophenone; 1-hydroxycyclohexyl phenyl ketone; 2-hydroxy-2-methylpropiophenone; 2-methylbenzophenone; 3-methylbenzophenone; methylbenzoylformate; 2-methyl-4′-(methylthio)-2-morpholinopropiophenone; phenanthrenequinone; 4′-phenoxyacetophenone; thioxanthen-9-one; ethyl phenyl(2,4,6-trimethylbenzoyl)phosphinate and mixtures thereof, preferably said UV initiator is selected from the group consisting of acetophenone; anisoin; anthraquinone; (benzene)tricarbonylchromium; benzil; benzoin; benzoin ethyl ether; benzoin isobutyl ether; benzoin methyl ether; benzophenone; 1-hydroxycyclohexyl phenyl ketone; 4-benzoylbiphenyl; 2-benzyl-2-(dimethylamino)-4′-morpholinobutyrophenone; 4,4′-bis(diethylamino)benzophenone; 4,4′-bis(dimethylamino)benzophenone; camphorquinone; 2-chlorothioxanthen-9-one; dibenzosuberenone; 2,2-diethoxyacetophenone; 4,4′-dihydroxybenzophenone; 2,2-dimethoxy-2-phenylacetophenone, 4-(dimethylamino)benzophenone, 4,4′-dimethylbenzil, 2,5-dimethylbenzophenone; 3,4-dimethylbenzophenone; diphenyl(2,4,6-trimethylbenzoyl)phosphine oxide; 2-hydroxy-2-methylpropiophenone; 4′-ethoxyacetophenone; 2-ethylanthraquinone; 3′-hydroxyacetophenone; 4′-hydroxyacetophenone; 3-hydroxybenzophenone; 4-hydroxybenzophenone; 1-hydroxycyclohexyl phenyl ketone; 2-hydroxy-2-methylpropiophenone; 2-methylbenzophenone; 3-methylbenzophenone; methylbenzoylformate; 2-methyl-4′-(methylthio)-2-morpholinopropiophenone; 4′-phenoxyacetophenone; thioxanthen-9-one; ethyl phenyl(2,4,6-trimethylbenzoyl)phosphinate and mixtures thereof; more preferably said UV initiator is selected from the group consisting of acetophenone; anisoin; anthraquinone; (benzene)tricarbonylchromium; benzoin ethyl ether; benzoin isobutyl ether; benzoin methyl ether; 4-benzoylbiphenyl; 2-benzyl-2-(dimethylamino)-4′-morpholinobutyrophenone; 4,4′-bis(diethylamino)benzophenone; 4,4′-bis(dimethylamino)benzophenone; camphorquinone; 2-chlorothioxanthen-9-one; dibenzosuberenone; 2,2-diethoxyacetophenone; 4,4′-dihydroxybenzophenone; 2,2-dimethoxy-2-phenylacetophenone; 4-(dimethylamino)benzophenone; 3,4-dimethylbenzophenone; diphenyl(2,4,6-trimethylbenzoyl)phosphine oxide; 2-hydroxy-2-methylpropiophenone; 2-ethylanthraquinone; 3′-hydroxyacetophenone; 4′-hydroxyacetophenone; 3-hydroxybenzophenone; 4-hydroxybenzophenone; 2-methyl-4′-(methylthio)-2-morpholinopropiophenone; 4′-phenoxyacetophenone; thioxanthen-9-one; ethyl phenyl(2,4,6-trimethylbenzoyl)phosphinate and mixtures thereof; most preferably said initiator is selected from the group consisting of 2,2-dimethoxy-2-phenylacetophenone; 4,4′-bis(diethylamino)benzophenone, 4,4′-bis(dimethylamino)benzophenone; camphorquinone; ethyl phenyl(2,4,6-trimethylbenzoyl)phosphinate and mixtures thereof, and said thermal initiator is selected from the group consisting of 2,3-dimethyl-2,3-diphenylbutane; tert-butyl hydroperoxide; tert-amyl hydroperoxide; cumyl hydroperoxide; 1,1,3,3-tetramethylbutyl hydroperoxide; isopropylcumyl hydroperoxide; isopropylcumyl hydroperoxide; 2,5-dimethyl-2,5-di(tert-butylperoxy)hexyne; 3,6,9-triethyl-3,6,9-trimethyl-1,4,7-triperoxonane; di(tert-butyl)peroxide; 2,5-dimethyl-2,5-di(tert-butylperoxy)hexane; di(tert-butylperoxy-isopropyl)benzene; tert-butyl cumyl peroxide; di-(tert-amyl)-peroxide; dicumyl peroxide; butyl 4,4-di(tert-butylperoxy)valerate; tert-butylperoxybenzoate; 2,2-di(tert-butylperoxy)butane; tert-amyl peroxy-benzoate; tert-butylperoxy-acetate; tert-butylperoxy-(2-ethylhexyl)carbonate; tert-butylperoxy isopropyl carbonate; tert-butyl peroxy-3,5,5-trimethyl-hexanoate; 1,1-di(tert-butylperoxy)cyclohexane; tert-amyl peroxyacetate; tert-amylperoxy-(2-ethylhexyl)carbonate; 1,1-di(tert-butylperoxy)-3,5,5-trimethylcyclohexane; 1,1-di(tert-amylperoxy)cyclohexane; tert-butyl-monoperoxy-maleate; 1,1′-azodi(hexahydrobenzonitrile); tert-butyl peroxy-isobutyrate; tert-butyl peroxydiethylacetate; tert-butyl peroxy-2-ethylhexanoate; dibenzoyl peroxide; tert-amyl peroxy-2-ethylhexanoate; di(4-methylbenzoyl)peroxide; 1,1,3,3-tetramethylbutyl peroxy-2-ethylhexanoate; 2,5-dimethyl-2,5-di(2-ethylhexanoylperoxy)hexane; 2,2′-azodi(2-methylbutyronitrile); 2,2′-azodi(isobutyronitrile); 2,2′-azodi(2,4-dimethylvaleronitrile) didecanoyl peroxide; dilauroyl peroxide; di(3,5,5-trimethylhexanoyl) peroxide; tert-amyl peroxypivalate; tert-butyl peroxyneoheptanoate; 1,1,3,3-tetramethylbutyl peroxypivalate; tert-butyl peroxypivalate; dicetyl peroxydicarbonate; dimyristyl peroxydicarbonate; di(2-ethylhexyl) peroxydicarbonate; di(4-tert-butylcyclohexyl) peroxydicarbonate; diisopropyl peroxydicarbonate; tert-butyl peroxyneodecanoate; di-sec-butyl peroxydicarbonate; tert-amyl peroxyneodecanoate; cumyl peroxyneoheptanoate; di(3-methoxybutyl) peroxydicarbonate; 1,1,3,3-tetramethylbutyl peroxyneodecanoate; cumyl peroxyneodecanoate; diisobutyryl peroxide and mixtures thereof; preferably said initiator is selected from the group consisting of 2,3-dimethyl-2,3-diphenylbutane; 2,5-dimethyl-2,5-di(tert-butylperoxy)hexyne; 3,6,9-triethyl-3,6,9-trimethyl-1,4,7-triperoxonane; di(tert-butyl)peroxide; 2,5-dimethyl-2,5-di(tert-butylperoxy)hexane; di(tert-butylperoxy-isopropyl)benzene; tert-butyl cumyl peroxide; di-(tert-amyl)-peroxide; dicumyl peroxide; butyl 4,4-di(tert-butylperoxy)valerate; 2,2-di(tert-butylperoxy)butane; tert-butylperoxy-acetate; tert-butylperoxy-(2-ethylhexyl)carbonate; tert-butylperoxy isopropyl carbonate; tert-butyl peroxy-3,5,5-trimethyl-hexanoate; 1,1-di(tert-butylperoxy)cyclohexane; tert-amyl peroxyacetate; tert-amylperoxy-(2-ethylhexyl)carbonate; 1,1-di(tert-butylperoxy)-3,5,5-trimethylcyclohexane; 1,1-di(tert-amylperoxy)cyclohexane; tert-butyl-monoperoxy-maleate; tert-butyl peroxy-isobutyrate; tert-butyl peroxydiethylacetate; tert-butyl peroxy-2-ethylhexanoate; tert-amyl peroxy-2-ethylhexanoate; di(4-methylbenzoyl)peroxide; 1,1,3,3-tetramethylbutyl peroxy-2-ethylhexanoate; 2,5-dimethyl-2,5-di(2-ethylhexanoylperoxy)hexane; didecanoyl peroxide; dilauroyl peroxide; di(3,5,5-trimethylhexanoyl) peroxide; tert-amyl peroxypivalate; tert-butyl peroxyneoheptanoate; 1,1,3,3-tetramethylbutyl peroxypivalate; tert-butyl peroxypivalate; dicetyl peroxydicarbonate; dimyristyl peroxydicarbonate; di(2-ethylhexyl) peroxydicarbonate; di(4-tert-butylcyclohexyl) peroxydicarbonate; diisopropyl peroxydicarbonate; tert-butyl peroxyneodecanoate; di-sec-butyl peroxydicarbonate; tert-amyl peroxyneodecanoate; cumyl peroxyneoheptanoate; di(3-methoxybutyl) peroxydicarbonate; 1,1,3,3-tetramethylbutyl peroxyneodecanoate; cumyl peroxyneodecanoate; diisobutyryl peroxide and mixtures thereof; more preferably said thermal initiator is selected from the group consisting of tert-butylperoxy-(2-ethylhexyl)carbonate; tert-butylperoxy isopropyl carbonate; tert-butyl peroxy-3,5,5-trimethyl-hexanoate; 1,1-di(tert-butylperoxy)cyclohexane; tert-amyl peroxyacetate; tert-amylperoxy-(2-ethylhexyl)carbonate; 1,1-di(tert-butylperoxy)-3,5,5-trimethylcyclohexane; 1,1-di(tert-amylperoxy)cyclohexane; tert-butyl-monoperoxy-maleate; tert-butyl peroxy-isobutyrate; tert-butyl peroxydiethylacetate; tert-butyl peroxy-2-ethylhexanoate; tert-amyl peroxy-2-ethylhexanoate; di(4-methylbenzoyl)peroxide; 1,1,3,3-tetramethylbutyl peroxy-2-ethylhexanoate; 2,5-dimethyl-2,5-di(2-ethylhexanoylperoxy)hexane; didecanoyl peroxide; dilauroyl peroxide; di(3,5,5-trimethylhexanoyl) peroxide; tert-amyl peroxypivalate; tert-butyl peroxyneoheptanoate; 1,1,3,3-tetramethylbutyl peroxypivalate; tert-butyl peroxypivalate; dicetyl peroxydicarbonate; dimyristyl peroxydicarbonate; di(2-ethylhexyl) peroxydicarbonate; di(4-tert-butylcyclohexyl) peroxydicarbonate; diisopropyl peroxydicarbonate; tert-butyl peroxyneodecanoate; di-sec-butyl peroxydicarbonate; tert-amyl peroxyneodecanoate; cumyl peroxyneoheptanoate; di(3-methoxybutyl) peroxydicarbonate; 1,1,3,3-tetramethylbutyl peroxyneodecanoate; cumyl peroxyneodecanoate; diisobutyryl peroxide; 2,2′-azodi(isobutyronitrile); 2,2′-azodi(2,4-dimethylvaleronitrile) and mixtures thereof; most preferably said initiator is selected from the group consisting of tert-butylperoxy-(2-ethylhexyl)carbonate; 2,2′-azodi(isobutyronitrile); 2,2′-azodi(2,4-dimethylvaleronitrile) and mixtures thereof; with the proviso that when said thiourea terminated polymer only has Structure 1 of the first paragraph of this section of this specification titled “Thiourea Terminated Polymer and Processes of Making and Using Same” said multifunctional thiol crosslinker has an average thiol functionality of greater than 2.

In this paragraph Applicants disclose the resin of the previous paragraph wherein said resin comprising: an inhibitor selected from the group consisting of phenothiazine, quinone monomethyl ether, butylated hydroxytoluene, hydroquinone, avobenzone, 2-nitrophenyl phenyl sulfide, 2-(2′-Hydroxy-3′,5′-di-tert-butyl-phenyl)-5-chlorobenzo-triazole, 2,2′-(2,5-thiophenediyl)bis(5-tert-butylbenzoxazole), Acid Orange 5, Acid Orange 7, Acid Orange 19 Acid Orange 20, Acid Red 13, Acid Red 88, Alcian Yellow, Alizarine Yellow R, Allura Red AC, Amaranth (dye), Amido Black 10B, Aniline Yellow, Azo Violet, Azorubine, Basic Red 18, Biebrich Scarlet, Bismarck Brown Y, Black 7984, Brilliant Black BN, Brown FK, Brown HT, Calconcarboxylic acid, Chrysoine resorcinol, Citrus Red 2, Congo Red, D&C Red 33, Direct Blue 1, Direct Blue 15, Disperse Orange 1, Eriochrome Black T, Evans Blue, Fast Yellow AB, Hydroxynaphthol Blue, Janus Green B, Lithol Rubine BK, Metanil Yellow, Methyl Orange, Methyl Red, Methyl Yellow, Mordant Brown 33, Mordant Red 19, Naphthol AS, Oil Red 0, Orange B, Orange G, Orange GGN, Para Red, Pigment Yellow 10, Ponceau 2R, Ponceau 3R, Ponceau 4R, Ponceau 6R, Ponceau S, Prontosil, Red 2G, Scarlet GN, Sirius Red, Solvent Black 3, Solvent Red 26, Solvent Yellow 56, Solvent Yellow 124, Sudan I, Sudan II, Sudan III, Sudan IV, Sudan Red 7B, Sudan Red G, Sudan Yellow 3G, Sunset Yellow FCF, Tartrazine, Tropaeolin, Trypan Blue, Yellow 2G and mixtures thereof, preferably said inhibitor is selected from the group consisting of Aniline Yellow, Azo Violet, Calconcarboxylic acid, Citrus Red 2, Disperse Orange 1, Janus Green B, Methyl Red, Methyl Yellow, Naphthol AS, Oil Red 0, Para Red, Solvent Black 3, Solvent Red 26, Solvent Yellow 56, Solvent Yellow 124, Sudan I, Sudan II, Sudan III, Sudan IV, Sudan Red 7B, Sudan Red G, Sudan Yellow 3G, 2,2′-(2,5-thiophenediyl)bis(5-tert-butyl benzoxazole) and mixtures thereof; more preferably said inhibitor is selected from the group consisting of Aniline Yellow, Azo Violet, Citrus Red 2, Disperse Orange 1, Methyl Yellow, Naphthol AS, Oil Red 0, Para Red, Solvent Black 3, Solvent Red 26, Solvent Yellow 56, Solvent Yellow 124, Sudan I, Sudan II, Sudan III, Sudan IV, Sudan Red 7B, Sudan Red G, Sudan Yellow 3G, 2,2′-(2,5-thiophenediyl)bis(5-tert-butyl benzoxazole) and mixtures thereof; most preferably said inhibitor is selected from the group consisting of Oil Red 0, Sudan I, Sudan II, Sudan III, Sudan IV, 2,2′-(2,5-thiophenediyl)bis(5-tert-butyl benzoxazole) and mixtures thereof; and/or an adjunct selected from the group consisting of acetamide, acetyltributylcitrate, benzyl benzoate, benzyl butyl phthalate, bis(2-ethylhexyl) adipate, bis(2-ethylhexyl) phthalate, centralite, 1,2-cyclohexane dicarboxylic acid diisononyl ester, dibutyl phthalate, dibutyl sebacate, diethylene glycol dinitrate, diisobutyl phthalate, diisodecyl phthalate, diisononyl phthalate, dimethyl adipate, dimethyl methylphosphonate, 2,4-dinitrotoluene, dioctyl adipate, dioctyl sebacate, dioctyl terephthalate, dipropylene glycol, biobased oils, epoxidized soybean oil, fatty acids (stearic, lauryl, linoleic, oleic), soybean oil, ethyl butyrate, ethylene carbonate, furoin, linseed oil, maleic acid dibutyl ester, naphtha, neopentyl glycol, triethylene glycol, paraffin, polybutene, polychlorinated biphenyl, polychlorinated terphenyl, propylene carbonate, tris(1-(2-methyl))aziridinyl phosphine oxide, trimesoyl-1-(2-ethyl)aziridine, tetraethylenepentamine acrylonitrile glycidol adduct, partially cyanoacrylated tetraethylenepentamine, isophthaloyl-bis(methyl-ethyleneimide), triacetin, tributyl phosphate, tricresyl phosphate, triethyl phosphate, triethylene glycol dinitrate, trimethylolethane trinitrate, metal oxides (alumina, iron oxide, titanium dioxide, zirconium oxide, zinc oxide), talc, glass (both fibers and beads), metal carbonates (including magnesium and calcium), salts (nitrates, perchlorates, sulfates), metals (magnesium, aluminum, iron, silver, copper, gold), carbon black, carbon nanotubes, graphene, graphene oxide, clays, cellulose, nanocellulose, precipitated silica, fumed silica, polyhedral oligomeric silsesquioxane, and mixtures thereof, preferably said one or more entrained adjuncts being selected from the group consisting of acetyltributylcitrate, benzyl benzoate, benzyl butyl phthalate, bis(2-ethylhexyl) adipate, bis(2-ethylhexyl) phthalate, centralite, 1,2-cyclohexane dicarboxylic acid diisononyl ester, dibutyl phthalate, dibutyl sebacate, diethylene glycol dinitrate, diisobutyl phthalate, diisodecyl phthalate, diisononyl phthalate, dimethyl adipate, dimethyl methylphosphonate, 2,4-dinitrotoluene, dioctyl adipate, dioctyl sebacate, dioctyl terephthalate, dipropylene glycol, biobased oils, ethyl butyrate, ethylene carbonate, furoin, maleic acid dibutyl ester, neopentyl glycol, triethylene glycol, polybutene, propylene carbonate, triacetin, tributyl phosphate, tricresyl phosphate, triethyl phosphate, triethylene glycol dinitrate, trimethylolethane trinitrate, metal oxides, metal carbonates, salts, metals, carbon black, clays, cellulose, nanocellulose, precipitated silica, fumed silica, and mixtures thereof, more preferably said one or more entrained adjuncts being selected from the group consisting of bis(2-ethylhexyl) adipate, bis(2-ethylhexyl) phthalate, dibutyl phthalate, dibutyl sebacate, diisobutyl phthalate, diisodecyl phthalate, diisononyl phthalate, dimethyl adipate, dioctyl adipate, dioctyl sebacate, dioctyl terephthalate, dipropylene glycol, ethyl butyrate, ethylene carbonate, furoin, maleic acid dibutyl ester, neopentyl glycol, triethylene glycol, polybutene, propylene carbonate, metal oxides, salts, metals, carbon black, cellulose, nanocellulose, fumed silica, and mixtures thereof, most preferably said one or more entrained adjuncts being selected from the group consisting of bis(2-ethylhexyl) adipate, dibutyl sebacate, dimethyl adipate, dioctyl adipate, dioctyl sebacate, triethylene glycol, fumed silica, metals, salts, and mixtures thereof.

In this paragraph Applicants disclose the resin of the previous paragraph having: a ratio of thiourea terminated polymer allyl groups to multifunctional thiol crosslinker thiol groups of about 0.8:1 to about 1.2:1, preferably said resin having a ratio of thiourea terminated polymer allyl groups to multifunctional thiol crosslinker thiol groups of about 0.9:1 to about 1.1:1, more preferably said resin having a ratio of thiourea terminated polymer allyl groups to multifunctional thiol crosslinker thiol groups of about 0.95:1 to about 1.05:1; most preferably said resin having a ratio of thiourea terminated polymer allyl groups to multifunctional thiol crosslinker thiol groups of about 1:1; and wherein said radical initiator is present in said composition, based on total composition weight at a level of from about 0.25 wt. % to about 15 wt. %; preferably said radical initiator is present in said composition, based on total composition weight at a level of from about 0.5 wt. % to about 10 wt. %; more preferably said radical initiator is present in said composition, based on total composition weight at a level of from about 0.75 wt. % to about 7.5 wt. %; most preferably said radical initiator is present in said composition, based on total composition weight at a level of from about 1 wt. % to about 5 wt. %; said optional inhibitor is present in said composition, based on total composition weight at a level of from about 0.01 wt. % to about 5 wt. %, preferably said optional inhibitor is present in said composition, based on total composition weight at a level of from about 0.02 wt. % to about 0.5 wt. %; said optional adjunct is present in said composition, based on total composition weight at a level of from about 0 wt. % to about 99 wt. %; preferably said one or more entrained adjuncts is present, based on said article mass percent, at a level of from about 5 wt. % to about 93 wt. %; more preferably said one or more entrained adjuncts is present, based on said article mass percent, at a level of from about 10 wt. % to about 91 wt. %; most preferably said one or more entrained adjuncts is present, based on said article mass percent, at a level of from about 15 wt. % to about 90 wt. %. When said resin is used in a casting process a UV and/or thermal initiator may be used, when said resin is used in a vat photopolymerization process a UV initiator along with an optional thermal initiator should be used in said resin, and when the resin is used in a direct ink write process a UV initiator along with a thermal initiator and a solid adjunct is required. The solid adjunct is employed so the art made from the resin will keep its shape during printing.

In this paragraph Applicants disclose process of making a resin said process comprising combining: a thiourea terminated polymer according to Structure 1 and/or Structure 2 of the first paragraph of this section of this specification titled “Thiourea Terminated Polymer and Processes of Making and Using Same”; a multifunctional thiol crosslinker, preferably said multifunctional thiol crosslinker is selected from the group consisting of 1,4-butanedithiol; 4,5-bis(mercaptomethyl)-o-xylene; 1,4-benzenedithiol; 4,4′-biphenyldithiol; 1,3,5-benzenetrithiol; 2,3-butanedithiol; 1,3-benzenedithiol; 1,10-decanedithiol; DL-dithiothreitol; dithioerythritol; 1,5-dimercaptonaphthalene; 3,6-dioxa-1,8-octanedithiol; 3,7-dithia-1,9-nonanedithiol; 1,2-ethanedithiol; 1,6-hexanedithiol; bis(2-mercaptoethyl) sulfide; 1,8-octanedithiol; 1,9-nonanedithiol 1,3-propanedithiol; 1,5-pentanedithiol; 4,4′-thiobisbenzenethiol; tetra(ethylene glycol) dithiol; 1,11-undecanedithiol; hexa(ethylene glycol) dithiol; 1,16-hexadecanedithiol; a thiol-functional polymer; ethylene bis(thioglycolate); trimethylolpropane tris(thioglycolate); ethylene glycol bis(3-mercaptopropionate); trimethylolpropane tris(3-mercaptopropionate); pentaerythritol tetrakis(3-mercaptopropionate); pentaerythritol tetrakis(mercaptoacetate) and mixtures thereof; more preferably said multifunctional thiol crosslinker is selected from the group consisting of trimethylolpropane tris(3-mercaptopropionate); pentaerythritol tetrakis(3-mercaptopropionate); ethylene glycol bis(3-mercaptopropionate); 3,6-dioxa-1,8-octanedithiol and mixtures thereof; and a radical initiator, preferably said radical initiator is a UV initiator and/or thermal initiator, preferably said UV initiator is selected from the group consisting of acetophenone; anisoin; anthraquinone; (benzene)tricarbonylchromium; benzil; benzoin; benzoin ethyl ether; benzoin isobutyl ether; benzoin methyl ether; benzophenone; 1-hydroxycyclohexyl phenyl ketone; 3,3′,4,4′-benzophenonetetracarboxylic dianhydride; 4-benzoylbiphenyl; 2-benzyl-2-(dimethylamino)-4′-morpholinobutyrophenone; 4,4′-bis(diethylamino)benzophenone; 4,4′-bis(dimethylamino)benzophenone; camphorquinone; 2-chlorothioxanthen-9-one; (cumene)cyclopentadienyliron(II) hexafluorophosphate; dibenzosuberenone; 2,2-diethoxyacetophenone; 4,4′-dihydroxybenzophenone; 2,2-dimethoxy-2-phenylacetophenone; 4-(dimethylamino)benzophenone; 4,4′-dimethylbenzil; 2,5-dimethylbenzophenone; 3,4-dimethylbenzophenone; diphenyl(2,4,6-trimethylbenzoyl)phosphine oxide; 2-hydroxy-2-methylpropiophenone; 4′-ethoxyacetophenone; 2-ethylanthraquinone; ferrocene; 3′-hydroxyacetophenone; 4′-hydroxyacetophenone; 3-hydroxybenzophenone; 4-hydroxybenzophenone; 1-hydroxycyclohexyl phenyl ketone; 2-hydroxy-2-methylpropiophenone; 2-methylbenzophenone; 3-methylbenzophenone; methylbenzoylformate; 2-methyl-4′-(methylthio)-2-morpholinopropiophenone; phenanthrenequinone; 4′-phenoxyacetophenone; thioxanthen-9-one; ethyl phenyl(2,4,6-trimethylbenzoyl)phosphinate and mixtures thereof, preferably said UV initiator is selected from the group consisting of acetophenone; anisoin; anthraquinone; (benzene)tricarbonylchromium; benzil; benzoin; benzoin ethyl ether; benzoin isobutyl ether; benzoin methyl ether; benzophenone; 1-hydroxycyclohexyl phenyl ketone; 4-benzoylbiphenyl; 2-benzyl-2-(dimethylamino)-4′-morpholinobutyrophenone; 4,4′-bis(diethylamino)benzophenone; 4,4′-bis(dimethylamino)benzophenone; camphorquinone; 2-chlorothioxanthen-9-one; dibenzosuberenone; 2,2-diethoxyacetophenone; 4,4′-dihydroxybenzophenone; 2,2-dimethoxy-2-phenylacetophenone, 4-(dimethylamino)benzophenone, 4,4′-dimethylbenzil, 2,5-dimethylbenzophenone; 3,4-dimethylbenzophenone; diphenyl(2,4,6-trimethylbenzoyl)phosphine oxide; 2-hydroxy-2-methylpropiophenone; 4′-ethoxyacetophenone; 2-ethylanthraquinone; 3′-hydroxyacetophenone; 4′-hydroxyacetophenone; 3-hydroxybenzophenone; 4-hydroxybenzophenone; 1-hydroxycyclohexyl phenyl ketone; 2-hydroxy-2-methylpropiophenone; 2-methylbenzophenone; 3-methylbenzophenone; methylbenzoylformate; 2-methyl-4′-(methylthio)-2-morpholinopropiophenone; 4′-phenoxyacetophenone; thioxanthen-9-one; ethyl phenyl(2,4,6-trimethylbenzoyl)phosphinate and mixtures thereof, more preferably said UV initiator is selected from the group consisting of acetophenone; anisoin; anthraquinone; (benzene)tricarbonylchromium; benzoin ethyl ether; benzoin isobutyl ether; benzoin methyl ether; 4-benzoylbiphenyl; 2-benzyl-2-(dimethylamino)-4′-morpholinobutyrophenone; 4,4′-bis(diethylamino)benzophenone; 4,4′-bis(dimethylamino)benzophenone; camphorquinone; 2-chlorothioxanthen-9-one; dibenzosuberenone; 2,2-diethoxyacetophenone; 4,4′-dihydroxybenzophenone; 2,2-dimethoxy-2-phenylacetophenone; 4-(dimethylamino)benzophenone; 3,4-dimethylbenzophenone; diphenyl(2,4,6-trimethylbenzoyl)phosphine oxide; 2-hydroxy-2-methylpropiophenone; 2-ethylanthraquinone; 3′-hydroxyacetophenone; 4′-hydroxyacetophenone; 3-hydroxybenzophenone; 4-hydroxybenzophenone; 2-methyl-4′-(methylthio)-2-morpholinopropiophenone; 4′-phenoxyacetophenone; thioxanthen-9-one; ethyl phenyl(2,4,6-trimethylbenzoyl)phosphinate and mixtures thereof; most preferably said initiator is selected from the group consisting of 2,2-dimethoxy-2-phenylacetophenone; 4,4′-bis(diethylamino)benzophenone, 4,4′-bis(dimethylamino)benzophenone; camphorquinone; ethyl phenyl(2,4,6-trimethylbenzoyl)phosphinate and mixtures thereof, and said thermal initiator is selected from the group consisting of 2,3-dimethyl-2,3-diphenylbutane; tert-butyl hydroperoxide; tert-amyl hydroperoxide; cumyl hydroperoxide; 1,1,3,3-tetramethylbutyl hydroperoxide; isopropylcumyl hydroperoxide; isopropylcumyl hydroperoxide; 2,5-dimethyl-2,5-di(tert-butylperoxy)hexyne; 3,6,9-triethyl-3,6,9-trimethyl-1,4,7-triperoxonane; di(tert-butyl)peroxide; 2,5-dimethyl-2,5-di(tert-butylperoxy)hexane; di(tert-butylperoxy-isopropyl)benzene; tert-butyl cumyl peroxide; di-(tert-amyl)-peroxide; dicumyl peroxide; butyl 4,4-di(tert-butylperoxy)valerate; tert-butylperoxybenzoate; 2,2-di(tert-butylperoxy)butane; tert-amyl peroxy-benzoate; tert-butylperoxy-acetate; tert-butylperoxy-(2-ethylhexyl)carbonate; tert-butylperoxy isopropyl carbonate; tert-butyl peroxy-3,5,5-trimethyl-hexanoate; 1,1-di(tert-butylperoxy)cyclohexane; tert-amyl peroxyacetate; tert-amylperoxy-(2-ethylhexyl)carbonate; 1,1-di(tert-butylperoxy)-3,5,5-trimethylcyclohexane; 1,1-di(tert-amylperoxy)cyclohexane; tert-butyl-monoperoxy-maleate; 1,1′-azodi(hexahydrobenzonitrile); tert-butyl peroxy-isobutyrate; tert-butyl peroxydiethylacetate; tert-butyl peroxy-2-ethylhexanoate; dibenzoyl peroxide; tert-amyl peroxy-2-ethylhexanoate; di(4-methylbenzoyl)peroxide; 1,1,3,3-tetramethylbutyl peroxy-2-ethylhexanoate; 2,5-dimethyl-2,5-di(2-ethylhexanoylperoxy)hexane; 2,2′-azodi(2-methylbutyronitrile); 2,2′-azodi(isobutyronitrile); 2,2′-azodi(2,4-dimethylvaleronitrile) didecanoyl peroxide; dilauroyl peroxide; di(3,5,5-trimethylhexanoyl) peroxide; tert-amyl peroxypivalate; tert-butyl peroxyneoheptanoate; 1,1,3,3-tetramethylbutyl peroxypivalate; tert-butyl peroxypivalate; dicetyl peroxydicarbonate; dimyristyl peroxydicarbonate; di(2-ethylhexyl) peroxydicarbonate; di(4-tert-butylcyclohexyl) peroxydicarbonate; diisopropyl peroxydicarbonate; tert-butyl peroxyneodecanoate; di-sec-butyl peroxydicarbonate; tert-amyl peroxyneodecanoate; cumyl peroxyneoheptanoate; di(3-methoxybutyl) peroxydicarbonate; 1,1,3,3-tetramethylbutyl peroxyneodecanoate; cumyl peroxyneodecanoate; diisobutyryl peroxide and mixtures thereof; preferably said initiator is selected from the group consisting of 2,3-dimethyl-2,3-diphenylbutane; 2,5-dimethyl-2,5-di(tert-butylperoxy)hexyne; 3,6,9-triethyl-3,6,9-trimethyl-1,4,7-triperoxonane; di(tert-butyl)peroxide; 2,5-dimethyl-2,5-di(tert-butylperoxy)hexane; di(tert-butylperoxy-isopropyl)benzene; tert-butyl cumyl peroxide; di-(tert-amyl)-peroxide; dicumyl peroxide; butyl 4,4-di(tert-butylperoxy)valerate; 2,2-di(tert-butylperoxy)butane; tert-butylperoxy-acetate; tert-butylperoxy-(2-ethylhexyl)carbonate; tert-butylperoxy isopropyl carbonate; tert-butyl peroxy-3,5,5-trimethyl-hexanoate; 1,1-di(tert-butylperoxy)cyclohexane; tert-amyl peroxyacetate; tert-amylperoxy-(2-ethylhexyl)carbonate; 1,1-di(tert-butylperoxy)-3,5,5-trimethylcyclohexane; 1,1-di(tert-amylperoxy)cyclohexane; tert-butyl-monoperoxy-maleate; tert-butyl peroxy-isobutyrate; tert-butyl peroxydiethylacetate; tert-butyl peroxy-2-ethylhexanoate; tert-amyl peroxy-2-ethylhexanoate; di(4-methylbenzoyl)peroxide; 1,1,3,3-tetramethylbutyl peroxy-2-ethylhexanoate; 2,5-dimethyl-2,5-di(2-ethylhexanoylperoxy)hexane; didecanoyl peroxide; dilauroyl peroxide; di(3,5,5-trimethylhexanoyl) peroxide; tert-amyl peroxypivalate; tert-butyl peroxyneoheptanoate; 1,1,3,3-tetramethylbutyl peroxypivalate; tert-butyl peroxypivalate; dicetyl peroxydicarbonate; dimyristyl peroxydicarbonate; di(2-ethylhexyl) peroxydicarbonate; di(4-tert-butylcyclohexyl) peroxydicarbonate; diisopropyl peroxydicarbonate; tert-butyl peroxyneodecanoate; di-sec-butyl peroxydicarbonate; tert-amyl peroxyneodecanoate; cumyl peroxyneoheptanoate; di(3-methoxybutyl) peroxydicarbonate; 1,1,3,3-tetramethylbutyl peroxyneodecanoate; cumyl peroxyneodecanoate; diisobutyryl peroxide and mixtures thereof; more preferably said thermal initiator is selected from the group consisting of tert-butylperoxy-(2-ethylhexyl)carbonate; tert-butylperoxy isopropyl carbonate; tert-butyl peroxy-3,5,5-trimethyl-hexanoate; 1,1-di(tert-butylperoxy)cyclohexane; tert-amyl peroxyacetate; tert-amylperoxy-(2-ethylhexyl)carbonate; 1,1-di(tert-butylperoxy)-3,5,5-trimethylcyclohexane; 1,1-di(tert-amylperoxy)cyclohexane; tert-butyl-monoperoxy-maleate; tert-butyl peroxy-isobutyrate; tert-butyl peroxydiethylacetate; tert-butyl peroxy-2-ethylhexanoate; tert-amyl peroxy-2-ethylhexanoate; di(4-methylbenzoyl)peroxide; 1,1,3,3-tetramethylbutyl peroxy-2-ethylhexanoate; 2,5-dimethyl-2,5-di(2-ethylhexanoylperoxy)hexane; didecanoyl peroxide; dilauroyl peroxide; di(3,5,5-trimethylhexanoyl) peroxide; tert-amyl peroxypivalate; tert-butyl peroxyneoheptanoate; 1,1,3,3-tetramethylbutyl peroxypivalate; tert-butyl peroxypivalate; dicetyl peroxydicarbonate; dimyristyl peroxydicarbonate; di(2-ethylhexyl) peroxydicarbonate; di(4-tert-butylcyclohexyl) peroxydicarbonate; diisopropyl peroxydicarbonate; tert-butyl peroxyneodecanoate; di-sec-butyl peroxydicarbonate; tert-amyl peroxyneodecanoate; cumyl peroxyneoheptanoate; di(3-methoxybutyl) peroxydicarbonate; 1,1,3,3-tetramethylbutyl peroxyneodecanoate; cumyl peroxyneodecanoate; diisobutyryl peroxide; 2,2′-azodi(isobutyronitrile); 2,2′-azodi(2,4-dimethylvaleronitrile) and mixtures thereof; most preferably said initiator is selected from the group consisting of tert-butylperoxy-(2-ethylhexyl)carbonate; 2,2′-azodi(isobutyronitrile); 2,2′-azodi(2,4-dimethylvaleronitrile) and mixtures thereof, and to form a mixture, preferably said mixture is homogenous; and an optional inhibitor an inhibitor selected from the group consisting of phenothiazine, quinone monomethyl ether, butylated hydroxytoluene, hydroquinone, avobenzone, 2-nitrophenyl phenyl sulfide, 2-(2′-Hydroxy-3′,5′-di-tert-butyl-phenyl)-5-chlorobenzo-triazole, 2,2′-(2,5-thiophenediyl)bis(5-tert-butylbenzoxazole), Acid Orange 5, Acid Orange 7, Acid Orange 19 Acid Orange 20, Acid Red 13, Acid Red 88, Alcian Yellow, Alizarine Yellow R, Allura Red AC, Amaranth (dye), Amido Black 10B, Aniline Yellow, Azo Violet, Azorubine, Basic Red 18, Biebrich scarlet, Bismarck Brown Y, Black 7984, Brilliant Black BN, Brown FK, Brown HT, Calconcarboxylic acid, Chrysoine resorcinol, Citrus Red 2, Congo Red, D&C Red 33, Direct Blue 1, Direct Blue 15, Disperse Orange 1, Eriochrome Black T, Evans Blue, Fast Yellow AB, Hydroxynaphthol Blue, Janus Green B, Lithol Rubine BK, Metanil Yellow, Methyl Orange, Methyl Red, Methyl Yellow, Mordant Brown 33, Mordant Red 19, Naphthol AS, Oil Red 0, Orange B, Orange G, Orange GGN, Para Red, Pigment Yellow 10, Ponceau 2R, Ponceau 3R, Ponceau 4R, Ponceau 6R, Ponceau S, Prontosil, Red 2G, Scarlet GN, Sirius Red, Solvent Black 3, Solvent Red 26, Solvent Yellow 56, Solvent Yellow 124, Sudan I, Sudan II, Sudan III, Sudan IV, Sudan Red 7B, Sudan Red G, Sudan Yellow 3G, Sunset Yellow FCF, Tartrazine, Tropaeolin, Trypan Blue, Yellow 2G and mixtures thereof; preferably said inhibitor is selected from the group consisting of Aniline Yellow, Azo Violet, Calconcarboxylic acid, Citrus Red 2, Disperse Orange 1, Janus Green B, Methyl Red, Methyl Yellow, Naphthol AS, Oil Red 0, Para Red, Solvent Black 3, Solvent Red 26, Solvent Yellow 56, Solvent Yellow 124, Sudan I, Sudan II, Sudan III, Sudan IV, Sudan Red 7B, Sudan Red G, Sudan Yellow 3G, 2,2′-(2,5-thiophenediyl)bis(5-tert-butyl benzoxazole) and mixtures thereof; more preferably said inhibitor is selected from the group consisting of Aniline Yellow, Azo Violet, Citrus Red 2, Disperse Orange 1, Methyl Yellow, Naphthol AS, Oil Red 0, Para Red, Solvent Black 3, Solvent Red 26, Solvent Yellow 56, Solvent Yellow 124, Sudan I, Sudan II, Sudan III, Sudan IV, Sudan Red 7B, Sudan Red G, Sudan Yellow 3G, 2,2′-(2,5-thiophenediyl)bis(5-tert-butyl benzoxazole) and mixtures thereof; most preferably said inhibitor is selected from the group consisting of Oil Red 0, Sudan I, Sudan II, Sudan III, Sudan IV, 2,2′-(2,5-thiophenediyl)bis(5-tert-butyl benzoxazole) and mixtures thereof; and/or an optional adjunct selected from the group consisting of acetamide, acetyltributylcitrate, benzyl benzoate, benzyl butyl phthalate, bis(2-ethylhexyl) adipate, bis(2-ethylhexyl) phthalate, centralite, 1,2-cyclohexane dicarboxylic acid diisononyl ester, dibutyl phthalate, dibutyl sebacate, diethylene glycol dinitrate, diisobutyl phthalate, diisodecyl phthalate, diisononyl phthalate, dimethyl adipate, dimethyl methylphosphonate, 2,4-dinitrotoluene, dioctyl adipate, dioctyl sebacate, dioctyl terephthalate, dipropylene glycol, biobased oils, epoxidized soybean oil, fatty acids (stearic, lauryl, linoleic, oleic), soybean oil, ethyl butyrate, ethylene carbonate, furoin, linseed oil, maleic acid dibutyl ester, naphtha, neopentyl glycol, triethylene glycol, paraffin, polybutene, polychlorinated biphenyl, polychlorinated terphenyl, propylene carbonate, tris(1-(2-methyl))aziridinyl phosphine oxide, trimesoyl-1-(2-ethyl)aziridine, tetraethylenepentamine acrylonitrile glycidol adduct, partially cyanoacrylated tetraethylenepentamine, isophthaloyl-bis(methyl-ethyleneimide), triacetin, tributyl phosphate, tricresyl phosphate, triethyl phosphate, triethylene glycol dinitrate, trimethylolethane trinitrate, metal oxides (alumina, iron oxide, titanium dioxide, zirconium oxide, zinc oxide), talc, glass (both fibers and beads), metal carbonates (including magnesium and calcium), salts (nitrates, perchlorates, sulfates), metals (magnesium, aluminum, iron, silver, copper, gold), carbon black, carbon nanotubes, graphene, graphene oxide, clays, cellulose, nanocellulose, precipitated silica, fumed silica, polyhedral oligomeric silsesquioxane, and mixtures thereof, preferably said one or more entrained adjuncts being selected from the group consisting of acetyltributylcitrate, benzyl benzoate, benzyl butyl phthalate, bis(2-ethylhexyl) adipate, bis(2-ethylhexyl) phthalate, centralite, 1,2-cyclohexane dicarboxylic acid diisononyl ester, dibutyl phthalate, dibutyl sebacate, diethylene glycol dinitrate, diisobutyl phthalate, diisodecyl phthalate, diisononyl phthalate, dimethyl adipate, dimethyl methylphosphonate, 2,4-dinitrotoluene, dioctyl adipate, dioctyl sebacate, dioctyl terephthalate, dipropylene glycol, biobased oils, ethyl butyrate, ethylene carbonate, furoin, maleic acid dibutyl ester, neopentyl glycol, triethylene glycol, polybutene, propylene carbonate, triacetin, tributyl phosphate, tricresyl phosphate, triethyl phosphate, triethylene glycol dinitrate, trimethylolethane trinitrate, metal oxides, metal carbonates, salts, metals, carbon black, clays, cellulose, nanocellulose, precipitated silica, fumed silica, and mixtures thereof, more preferably said one or more entrained adjuncts being selected from the group consisting of bis(2-ethylhexyl) adipate, bis(2-ethylhexyl) phthalate, dibutyl phthalate, dibutyl sebacate, diisobutyl phthalate, diisodecyl phthalate, diisononyl phthalate, dimethyl adipate, dioctyl adipate, dioctyl sebacate, dioctyl terephthalate, dipropylene glycol, ethyl butyrate, ethylene carbonate, furoin, maleic acid dibutyl ester, neopentyl glycol, triethylene glycol, polybutene, propylene carbonate, metal oxides, salts, metals, carbon black, cellulose, nanocellulose, fumed silica, and mixtures thereof, most preferably said one or more entrained adjuncts being selected from the group consisting of bis(2-ethylhexyl) adipate, dibutyl sebacate, dimethyl adipate, dioctyl adipate, dioctyl sebacate, triethylene glycol, fumed silica, metals, salts, and mixtures thereof. In one aspect, said mixture is formed by dissolving any solid components in any liquid components, preferably while said dissolving step is being conducted.

In this paragraph Applicants disclose the process of the previous paragraph wherein said mixture has a ratio of thiourea terminated polymer allyl groups to multifunctional thiol crosslinker thiol groups of about 0.8:1 to about 1.2:1, preferably said resin having a ratio of thiourea terminated polymer allyl groups to multifunctional thiol crosslinker thiol groups of about 0.9:1 to about 1.1:1, more preferably said resin having a ratio of thiourea terminated polymer allyl groups to multifunctional thiol crosslinker thiol groups of about 0.95:1 to about 1.05:1; most preferably said resin having a ratio of thiourea terminated polymer allyl groups to multifunctional thiol crosslinker thiol groups of about 1:1; and said radical initiator is present in said mixture, based on total mixture weight at a level of from about 0.25 wt. % to about 15 wt. %; preferably said radical initiator is present in said mixture, based on total mixture weight at a level of from about 0.5 wt. % to about 10 wt. %; more preferably said radical initiator is present in said composition, based on total composition weight at a level of from about 0.75 wt. % to about 7.5 wt. %; most preferably said radical initiator is present in said composition, based on total composition weight at a level of from about 1 wt. % to about 5 wt. %.

In this paragraph Applicants disclose the process of the previous paragraph wherein said mixture has a ratio of thiourea terminated polymer allyl groups to multifunctional thiol crosslinker thiol groups of about 0.8:1 to about 1.2:1, preferably said resin having a ratio of thiourea terminated polymer allyl groups to multifunctional thiol crosslinker thiol groups of about 0.9:1 to about 1.1:1, more preferably said resin having a ratio of thiourea terminated polymer allyl groups to multifunctional thiol crosslinker thiol groups of about 0.95:1 to about 1.05:1; most preferably said resin having a ratio of thiourea terminated polymer allyl groups to multifunctional thiol crosslinker thiol groups of about 1:1; said radical initiator is present in said mixture, based on total mixture weight at a level of from about 0.25 wt. % to about 15 wt. %; preferably said radical initiator is present in said mixture, based on total mixture weight at a level of from about 0.5 wt. % to about 10 wt. %; more preferably said radical initiator is present in said composition, based on total composition weight at a level of from about 0.75 wt. % to about 7.5 wt. %; most preferably said radical initiator is present in said composition, based on total composition weight at a level of from about 1 wt. % to about 5 wt. %; said optional inhibitor is present in said composition, based on total composition weight at a level of from about 0.01 wt. % to about 5 wt. %, preferably said optional inhibitor is present in said composition, based on total composition weight at a level of from about 0.02 wt. % to about 0.5 wt. %; and said optional adjunct is present in said composition, based on total composition weight at a level of from about 0 wt. % to about 99 wt. %; preferably said one or more entrained adjuncts is present, based on said article mass percent, at a level of from about 5 wt. % to about 93 wt. %; more preferably said one or more entrained adjuncts is present, based on said article mass percent, at a level of from about 10 wt. % to about 91 wt. %; most preferably said one or more entrained adjuncts is present, based on said article mass percent, at a level of from about 15 wt. % to about 90 wt. %.

In this paragraph Applicants disclose a method of making an article comprising a thiourea polymer network, said method comprising 3D printing or casting any resin disclosed in this section of this specification titled “Thiourea Terminated Polymer and Processes of Making and Using Same”, preferably said method comprises casting, direct ink writing, and/or VP 3D printing said resin.

In this paragraph Applicants disclose the method of the previous paragraph comprising post thermal curing said article, preferably said thermally post curing comprises heating the green article in an oven between 40° C. and 150° C. for between 1 minute and 1 week; more preferably said thermally post curing comprises heating the green article in an oven between 50° C. and 120° C. for between 15 minutes and 24 hours, most preferably said thermally post curing comprises heating the green article in an oven between 60° C. and 100° C. for between 1 hour and 4 hours. You typically need to post thermally cure said article if the 3D printing is a direct ink writing process.

In this paragraph Applicants disclose the method of the previous paragraph comprising direct ink writing and wherein said resin comprises a UV initiator, an optional thermal initiator and a solid adjunct, preferably said resin comprises a UV initiator, a thermal initiator and a solid adjunct, more preferably said resin comprises, based on total article weight percent of from about 1 wt. % to 30 wt. % of a solid adjunct selected from the group consisting of fumed silica, nanocellulose, clay, carbon black, and mixtures thereof; more preferably said composition comprises about 3 wt. % to 25 wt. % of a solid adjunct selected from the group consisting of fumed silica, nanocellulose, clay, carbon black and mixtures thereof; more preferably said composition comprises about 5 wt. % to 15 wt. % of a solid adjunct selected from the group consisting of fumed silica, nanocellulose, clay, carbon black and mixtures thereof, most preferably said composition comprises 8 wt. % to 12 wt. % of a solid adjunct selected from the group consisting of fumed silica, nanocellulose, clay, carbon black and mixtures thereof.

In this paragraph Applicants disclose an article comprising a polymer network derived from a thiourea terminated polymer according to the first paragraph of the section of this specification titled “Thiourea Terminated Polymer and Processes of Making and Using Same”, said polymer network having a self-healing index of 50%-100%, preferably said polymer network having a self-healing index of 60%-100%, more preferably said polymer network having a self-healing index of 70%-100%, most preferably said polymer network having a self-healing index of 80%-100%; said polymer network having a reprocessability index of 50%-100%, preferably said polymer network having a reprocessability index of 60%-100%, more preferably said polymer network having a reprocessability index of 70%-100%, most preferably said polymer network having a reprocessability index of 80%-100%; and/or having a crosslink density of from about 1×10⁻⁵ mol/cm³ to about 0.01 mol/cm³, preferably from about 1×10⁻⁴ mol/cm³ to about 5×10⁻³ mol/cm³, more preferably from about 2×10⁻⁴ mol/cm³ to about 1×10⁻³ mol/cm³, most preferably from about 3×10⁻⁴ mol/cm³ to about 5×10⁻⁴ mol/cm³. Articles that typically have crosslinking density on the lower end of Applicants' range of crosslinking density include solid rocket propellant grain, sealants, matrix component for stretchable electronics, inflatable grippers. Articles that typically have crosslinking density in the midrange of Applicants' range of crosslinking density include gaskets, seals, hoses, grips, responsive surfaces, shoe insoles, lattices, and dust shields, and articles that typically have crosslinking density in the high range of Applicants' range of crosslinking density include bushings, solid wheels, bumpers, shoe soles.

In this paragraph Applicants disclose the article of the previous paragraph said article comprising one or more entrained adjuncts, said one or more entrained adjuncts being selected from the group consisting of acetamide, dimethylformamide, acetyltributylcitrate, benzyl benzoate, benzyl butyl phthalate, bis(2-ethylhexyl) adipate, bis(2-ethylhexyl) phthalate, centralite, 1,2-cyclohexane dicarboxylic acid diisononyl ester, dibutyl phthalate, dibutyl sebacate, diethylene glycol dinitrate, diisobutyl phthalate, diisodecyl phthalate, diisononyl phthalate, dimethyl adipate, dimethyl methylphosphonate, 2,4-dinitrotoluene, dioctyl adipate, dioctyl sebacate, dioctyl terephthalate, dipropylene glycol, biobased oils, epoxidized soybean oil, fatty acids, soybean oil, ethyl butyrate, ethylene carbonate, furoin, linseed oil, maleic acid dibutyl ester, naphtha, neopentyl glycol, triethylene glycol, paraffin, polybutene, polychlorinated biphenyl, polychlorinated terphenyl, propylene carbonate, tris(1-(2-methyl))aziridinyl phosphine oxide, trimesoyl-1-(2-ethyl)aziridine, tetraethylenepentamine acrylonitrile glycidol adduct, partially cyanoacrylated tetraethylenepentamine, isophthaloyl-bis(methyl-ethyleneimide), triacetin, tributyl phosphate, tricresyl phosphate, triethyl phosphate, triethylene glycol dinitrate, trimethylolethane trinitrate, metal oxides talc, glass, metal carbonates, salts, metals, carbon black, carbon nanotubes, graphene, graphene oxide, clays, cellulose, nanocellulose, precipitated silica, fumed silica, polyhedral oligomeric silsesquioxane and mixtures thereof. Liquid adjuncts act as plasticizers and bonding agents, and can impart increased flexibility and processability to the part, improving the mechanical properties like extensibility, in particular in the low temperature range. Solids can impart a number of properties, from reinforcement to thickener to oxidizer and/or fuel in a solid propellant. Fumed silica is a thickening agent and allows the use of direct ink writing. Aluminum and ammonium perchlorate are fuel and oxidizer for solid rocket motors. Organic additives can do a number of things, like tougheners, nanomaterials for nanocomposites (polyhedral oligomeric silsesquioxane, clay, carbon nanotube, etc.), or energetics to make nanocomposites or 3D printed explosives.

In this paragraph Applicants disclose the article of the previous paragraph wherein said one or more entrained adjuncts is present, based on said article weight percent, at a level of from about 0 wt. % to about 99 wt. %; preferably said one or more entrained adjuncts is present, based on said article mass percent, at a level of from about 5 wt. % to about 93 wt. %; more preferably said one or more entrained adjuncts is present, based on said article mass percent, at a level of from about 10 wt. % to about 91 wt. %; most preferably said one or more entrained adjuncts is present, based on said article mass percent, at a level of from about 15 wt. % to about 90 wt. %.

In this paragraph Applicants disclose solid rocket propellant grain, sealant, matrix component for stretchable electronics, inflatable gripper, gasket, seal, hose, grip, responsive surface, shoe insole, lattice, dust shield, bushing, solid wheel, bumper, or shoe sole comprising an article according to previous three paragraphs. In one aspect, a solid rocket propellant grain, sealant, matrix component for stretchable electronics, inflatable gripper, gasket, seal, hose, and/or grip comprises an article according to any preceding claim. In another aspect, a solid rocket propellant grain, sealant, matrix component for stretchable electronics, gasket, and/or seal comprises an article according to any preceding claim. In another aspect, a solid propellant comprises an article according to any preceding claim. As will be appreciated by the skilled artisan, incorporating an article according to any preceding claim into the aforementioned solid rocket propellant grain, sealant, matrix component for stretchable electronics, inflatable gripper, gasket, seal, hose, grip, responsive surface, shoe insole, lattice, dust shield, bushing, solid wheel, bumper, and/or shoe sole can be achieved via methods known to the skilled artisan including methods taught via U.S. Pat. No. 8,844,133 B2, USPA 2019/0390081 A1, U.S. Pat. No. 9,788,604 B2, USPA 2020/0032062 A1. Such teachings are sufficient to produce the final solid rocket propellant grain, sealant, matrix component for stretchable electronics, inflatable gripper, gasket, seal, hose, grip, responsive surface, shoe insole, lattice, dust shield, bushing, solid wheel, bumper, and/or shoe sole.

### Test Methods

For purposes of this application, the crosslink density is determined using the method outlined by Mujtaba et al., where the plateau modulus is determined using dynamic mechanical analysis, and the modulus is plugged in to the equation G vkT, where G is the rubbery plateau modulus, v is the crosslink density, k is the gas constant, and T is the temperature.

For purposes of this application, the number average molecular weight of a polymer is determined using the following method: Nuclear magnetic resonance spectroscopy will be taken of the polymer sample. The peak corresponding to the terminal alkene protons (terminal CH₂ group on the alkene, 5.2 ppm) will be integrated. The peak corresponding to the protons on the backbone methyl group (−CH₃, 1.14 ppm) will be integrated. For alkene-functionalized thiourea polymers, the integral of the peak at 1.14 ppm will be divided by the integral of the peak at 5.2 ppm, multiplied by the number of protons in the terminal CH₂ group on the terminal alkenes, and divided by the number of protons in each backbone methyl group. That number will be multiplied by the molecular weight of one repeat unit and added to the molecular weight of the end groups to get the number average molecular weight of the polymer.

For purposes of this application, the self-healing index is determined using the following method: ASTM D412C shaped samples will be tested with a uniaxial tensile tester. After fracture, the two pieces will be manually reattached, then “healed” by heating to a 140° C. for one hour. The “healed” samples will be tested with a uniaxial tensile tester. The self-healing index will be calculated as the tensile strength of the “healed” sample divided by the tensile strength of the original sample, expressed as a percentage.

For purposes of this application, the reprocessability index is determined using the following method: ASTM D412C shaped samples will be tested with a uniaxial tensile tester. After fracture, the sample will be cut into small pieces and “reprocessed” into a film by pressing at 140° C. and 4 MPa of pressure for 30 minutes. The “reprocessed” film will be cut into ASTM D412C shaped samples that will be tested with a uniaxial tensile tester. The reprocessability index will be calculated as the tensile strength of the “reprocessed” sample divided by the tensile strength of the original sample, expressed as a percentage.

### EXAMPLES

The following examples and methods are presented as illustrative of the present invention or methods of carrying out the invention and are not restrictive or limiting of the scope of the invention in any manner.

Example 1—Synthesis of alkene-trifunctionalized thiourea polymer is as follows:

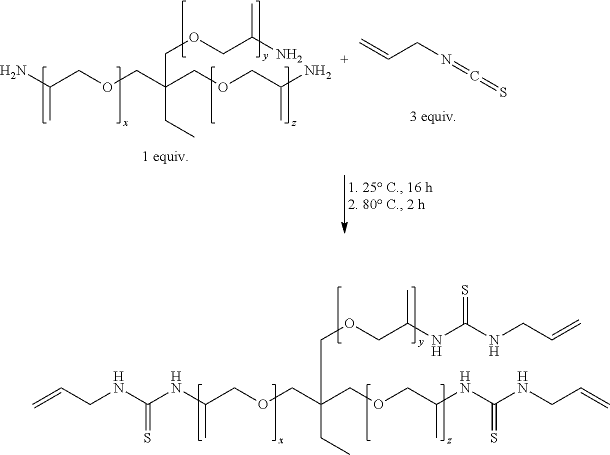

Allyl isothiocyanate (45.9 mL, 3.0 equiv.) was added dropwise to trifunctional amine-terminated poly(propylene oxide) with a molecular weight of approximately 3000 g/mol (500.00 g) and stirred overnight. Then, the mixture was purified by heating to 80° C. for 2 hours (533 g, 97%).

Example 2—Alternate synthesis of alkene-trifunctionalized thiourea polymer is as follows:

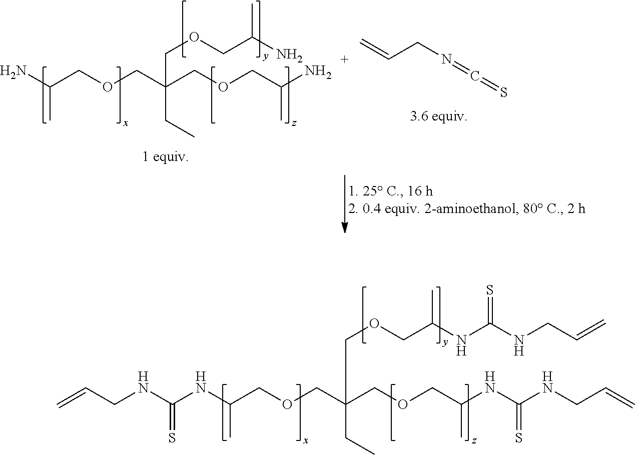

Allyl isothiocyanate (3.1 mL, 3.6 equiv.) was added dropwise to trifunctional amine-terminated poly(propylene oxide) with a molecular weight of approximately 5000 g/mol (50 g) in 100 mL of ethyl acetate, then the solution was stirred overnight. 2-aminoethanol (0.21 g, 0.4 equiv.) was added to the reaction and stirred for 2 hours at 80° C. The solution was washed with water (100 mL×3). Saturated sodium chloride was added to help separate the phases. The organic phase was dried with anhydrous magnesium sulfate, filtered, and the solvent was removed under reduced pressure (44.3 g, 84%).

Example 3—Synthesis of alkene-difunctionalized thiourea polymer is as follows:

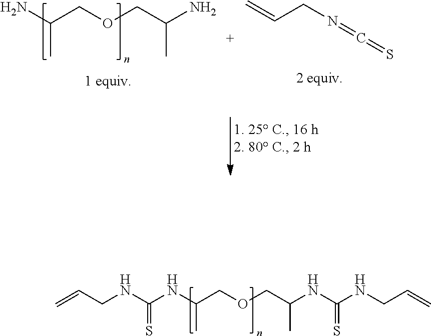

Allyl isothiocyanate (23.6 mL, 2.0 equiv.) was added dropwise to difunctional amine-terminated poly(propylene oxide) with a molecular weight of approximately 2000 g/mol (250.00 g) and stirred overnight. Then, the mixture was purified by heating to 80° C. for 2 hours (270.48 g, 99%).

Example 4—UV Casting. Ethyl phenyl(2,4,6-trimethylbenzoyl)phosphinate (0.23 g) was dissolved in 3,6-dioxa-1,8-octanedithiol (1.21 g) with gentle heating. Alkene-trifunctionalized thiourea polymer from Example 1 (15.00 g) was added and mixed in a dual axis centrifuge for 2 minutes at 2300 rpm. The resulting liquid resin was poured into a mold and irradiated with 405 nm UV light for 20 minutes, yielding a solid monolithic rubber with a Shore A hardness of 32.

Example 5—UV Casting. Ethyl phenyl(2,4,6-trimethylbenzoyl)phosphinate (0.13 g) was dissolved in 3,6-dioxa-1,8-octanedithiol (0.68 g) with gentle heating. Alkene-trifunctionalized thiourea polymer from Example 2 (15.00 g) was added and mixed in a dual axis centrifuge for 2 minutes at 2300 rpm. The resulting liquid resin was poured into a mold and irradiated with 405 nm UV light for 20 minutes, yielding a solid monolithic rubber with a Shore A hardness of 9.

Example 6—UV Casting. Ethyl phenyl(2,4,6-trimethylbenzoyl)phosphinate (0.34 g) was dissolved in trimethylolpropane tris(3-mercaptopropionate) (3.54 g) with gentle heating. Alkene-difunctionalized thiourea polymer from Example 3 (30.00 g) was added and mixed in a dual axis centrifuge for 2 minutes at 2300 rpm. The resulting liquid resin was poured into a mold and irradiated with 405 nm UV light for 20 minutes, yielding a solid monolithic rubber with a Shore A hardness of 35.

Example 7—UV Casting. Ethyl phenyl(2,4,6-trimethylbenzoyl)phosphinate (0.34 g) was dissolved in trimethylolpropane tris(3-mercaptopropionate) (3.54 g) with gentle heating. Alkene-trifunctionalized thiourea polymer from Example 1 (30.00 g) was added and mixed in a dual axis centrifuge for 2 minutes at 2300 rpm. The resulting liquid resin was poured into a mold and irradiated with 405 nm UV light for 20 minutes, yielding a solid monolithic rubber with a Shore A hardness of 56.

Example 8—UV Casting. Ethyl phenyl(2,4,6-trimethylbenzoyl)phosphinate (0.33 g) was dissolved in pentaerythritol tetrakis(3-mercaptopropionate) (3.25 g) with gentle heating. An alkene-trifunctionalized thiourea polymer from Example 1 (30.00 g) was added and mixed in a dual axis centrifuge for 2 minutes at 2300 rpm. The resulting liquid resin was poured into a mold and irradiated with 405 nm UV light for 20 minutes, yielding a solid monolithic rubber with a Shore A hardness of 58.

Example 9—Direct ink writing with UV and thermal cure. Ethyl phenyl(2,4,6-trimethylbenzoyl)phosphinate (0.43 g) and azobisisobutyronitrile (1.30 g) were added, and the mixture was gently heated to dissolve the initiators. Alkene-trifunctionalized thiourea polymer from Example 1 (40.00 g) and 3.24 g 3,6-dioxa-1,8-octanedithiol were added to the mixture, and the liquids were mixed in a dual axis centrifuge at 2300 rpm for 2 minutes to form a liquid resin. After mixing, 4.00 g hydrophobic fumed silica was added on top of the liquid resin that was subjected to a second mixing step for 2 min at 2300 rpm. After the second mixing, a thixotropic paste was obtained and transferred to a syringe. The syringe was used in a direct ink write printer to print a cube with approximate length of 20 mm. The 20 mm height corresponds to ten layers at 2 mm each. Each layer was cured for 30 s in a UV chamber before the next layer was deposited. The final article was cured in an oven at 60° C. for 7 days to yield a monolithic cube.

Example 10—Thermal casting. Alkene-trifunctionalized thiourea polymer from Example 1 (15.00 g), 3,6-dioxa-1,8-octanedithiol (1.21 g) and azobisisobutyronitrile (0.49 g) were added to a mixing cup and mixed in a dual axis centrifuge at 2300 rpm for 2 min to form a liquid resin. The resulting liquid resin was poured into a mold and cured at 60° C. for 7 days yielding a solid monolithic rubber.

Example 11—Vat photopolymerization. Ethyl phenyl(2,4,6-trimethylbenzoyl)phosphinate (0.43 g) was dissolved in 3.24 g 3,6-dioxa-1,8-octanedithiol. Alkene-trifunctionalized thiourea polymer from Example 1 (40.00 g) was added to the cup and mixed in a dual axis centrifuge for 2 min at 2300 rpm to form a liquid resin. The resulting liquid resin was used as a resin for VP with a Hunter S 3D printer from Flash Forge (Los Angeles, CA). A disk with approximate diameter of 22.5 mm and height of 7.5 mm was printed with a 100 m layer height, five burn-in layers at 100 s per layer, and 60 s cure time for each subsequent layer.

Suitable difunctional amine-terminated polypropylene oxides, include but are not limited to, are known as JEFFAMINE® D230 and JEFFAMINE® D2000 and suitable trifunctional amine-terminated polypropylene oxides known as JEFFAMINE® T403, JEFFAMINE® T3000 and JEFFAMINE® T5000 can be obtained from Huntsman Corporation (The Woodlands, TX). Remaining chemicals can be obtained from MilliporeSigma (St. Louis, MO), Thermo Fisher Scientific Inc. (Hampton, NH), and TCI America Inc. (Portland, OR). An example of the UV chamber used for cure is the Form Cure made by Formlabs (Somerville, MA).

While the present invention has been illustrated by the description of one or more embodiments thereof, and while the embodiments have been described in considerable detail, they are not intended to restrict or in any way limit the scope of the appended claim to such detail. Additional advantages and modification will be readily apparent to those skilled in the art. The invention in its broader aspects is therefore not limited to the specific details, representative apparatus and methods and illustrative examples shown and described. Accordingly, departures may be made from such details without departing from the scope or the spirit of the general inventive concept exemplified herein.

What is claimed is:

1. A thiourea terminated polymer, said thiourea terminated polymer comprising allyl groups, said thiourea terminated polymer having Structure 1 or Structure 2 below 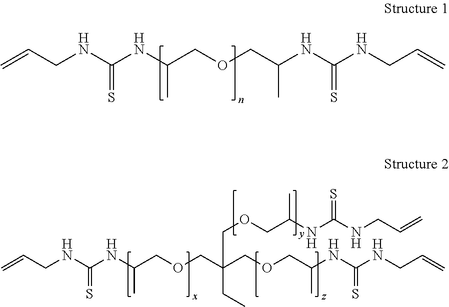
wherein
a) for Structure 1 the indice n is an integer from about 1 to about 430, preferably said indice n is an integer from about 2 to about 170, more preferably said indice n is an integer from about 6 to about 33; and
b) for Structure 2 the sum of indices x, y and z is an integer from about 3 to about 170, with the proviso that each of x, y and z are at least 1, preferably the sum of indices x, y and z is an integer from about 4 to about 120 with the proviso that each of x, y and z are at least 1, more preferably the sum of indices x, y and z is an integer from about 5 to about 84 with the proviso that each of x, y and z are at least 1.

2. A resin comprising:
a) a thiourea terminated polymer according to Structure 1 and/or Structure 2 of claim 1;
b) a multifunctional thiol crosslinker, preferably said multifunctional thiol crosslinker is selected from the group consisting of 1,4-butanedithiol; 4,5-bis(mercaptomethyl)-o-xylene; 1,4-benzenedithiol; 4,4′-biphenyldithiol; 1,3,5-benzenetrithiol; 2,3-butanedithiol; 1,3-benzenedithiol; 1,10-decanedithiol; DL-dithiothreitol; dithioerythritol; 1,5-dimercaptonaphthalene; 3,6-dioxa-1,8-octanedithiol; 3,7-dithia-1,9-nonanedithiol; 1,2-ethanedithiol; 1,6-hexanedithiol; bis(2-mercaptoethyl) sulfide; 1,8-octanedithiol; 1,9-nonanedithiol 1,3-propanedithiol; 1,5-pentanedithiol; 4,4′-thiobisbenzenethiol; tetra(ethylene glycol) dithiol; 1,11-undecanedithiol; hexa(ethylene glycol) dithiol; 1,16-hexadecanedithiol; a thiol-functional polymer; ethylene bis(thioglycolate); trimethylolpropane tris(thioglycolate); ethylene glycol bis(3-mercaptopropionate); trimethylolpropane tris(3-mercaptopropionate); pentaerythritol tetrakis(3-mercaptopropionate); pentaerythritol tetrakis(mercaptoacetate) and mixtures thereof; more preferably said multifunctional thiol crosslinker is selected from the group consisting of trimethylolpropane tris(3-mercaptopropionate); pentaerythritol tetrakis(3-mercaptopropionate); ethylene glycol bis(3-mercaptopropionate); 3,6-dioxa-1,8-octanedithiol and mixtures thereof; and
c) a radical initiator, preferably said radical initiator is a UV initiator and/or thermal initiator, preferably said UV initiator is selected from the group consisting of acetophenone; anisoin; anthraquinone; (benzene)tricarbonylchromium; benzil; benzoin; benzoin ethyl ether; benzoin isobutyl ether; benzoin methyl ether; benzophenone; 1-hydroxycyclohexyl phenyl ketone; 3,3′,4,4′-benzophenonetetracarboxylic dianhydride; 4-benzoylbiphenyl; 2-benzyl-2-(dimethylamino)-4′-morpholinobutyrophenone; 4,4′-bis(diethylamino)benzophenone; 4,4′-bis(dimethylamino)benzophenone; camphorquinone; 2-chlorothioxanthen-9-one; (cumene)cyclopentadienyliron(II) hexafluorophosphate; dibenzosuberenone; 2,2-diethoxyacetophenone; 4,4′-dihydroxybenzophenone; 2,2-dimethoxy-2-phenylacetophenone; 4-(dimethylamino)benzophenone; 4,4′-dimethylbenzil; 2,5-dimethylbenzophenone; 3,4-dimethylbenzophenone; diphenyl(2,4,6-trimethylbenzoyl)phosphine oxide; 2-hydroxy-2-methylpropiophenone; 4′-ethoxyacetophenone; 2-ethylanthraquinone; ferrocene; 3′-hydroxyacetophenone; 4′-hydroxyacetophenone; 3-hydroxybenzophenone; 4-hydroxybenzophenone; 1-hydroxycyclohexyl phenyl ketone; 2-hydroxy-2-methylpropiophenone; 2-methylbenzophenone; 3-methylbenzophenone; methylbenzoylformate; 2-methyl-4′-(methylthio)-2-morpholinopropiophenone; phenanthrenequinone; 4′-phenoxyacetophenone; thioxanthen-9-one; ethyl phenyl(2,4,6-trimethylbenzoyl)phosphinate and mixtures thereof; preferably said UV initiator is selected from the group consisting of acetophenone; anisoin; anthraquinone; (benzene)tricarbonylchromium; benzil; benzoin; benzoin ethyl ether; benzoin isobutyl ether; benzoin methyl ether; benzophenone; 1-hydroxycyclohexyl phenyl ketone; 4-benzoylbiphenyl; 2-benzyl-2-(dimethylamino)-4′-morpholinobutyrophenone; 4,4′-bis(diethylamino)benzophenone; 4,4′-bis(dimethylamino)benzophenone; camphorquinone; 2-chlorothioxanthen-9-one; dibenzosuberenone; 2,2-diethoxyacetophenone; 4,4′-dihydroxybenzophenone; 2,2-dimethoxy-2-phenylacetophenone, 4-(dimethylamino)benzophenone, 4,4′-dimethylbenzil, 2,5-dimethylbenzophenone; 3,4-dimethylbenzophenone; diphenyl(2,4,6-trimethylbenzoyl)phosphine oxide; 2-hydroxy-2-methylpropiophenone; 4′-ethoxyacetophenone; 2-ethylanthraquinone; 3′-hydroxyacetophenone; 4′-hydroxyacetophenone; 3-hydroxybenzophenone; 4-hydroxybenzophenone; 1-hydroxycyclohexyl phenyl ketone; 2-hydroxy-2-methylpropiophenone; 2-methylbenzophenone; 3-methylbenzophenone; methylbenzoylformate; 2-methyl-4′-(methylthio)-2-morpholinopropiophenone; 4′-phenoxyacetophenone; thioxanthen-9-one; ethyl phenyl(2,4,6-trimethylbenzoyl)phosphinate and mixtures thereof; more preferably said UV initiator is selected from the group consisting of acetophenone; anisoin; anthraquinone; (benzene)tricarbonylchromium; benzoin ethyl ether; benzoin isobutyl ether; benzoin methyl ether; 4-benzoylbiphenyl; 2-benzyl-2-(dimethylamino)-4′-morpholinobutyrophenone; 4,4′-bis(diethylamino)benzophenone; 4,4′-bis(dimethylamino)benzophenone; camphorquinone; 2-chlorothioxanthen-9-one; dibenzosuberenone; 2,2-diethoxyacetophenone; 4,4′-dihydroxybenzophenone; 2,2-dimethoxy-2-phenylacetophenone; 4-(dimethylamino)benzophenone; 3,4-dimethylbenzophenone; diphenyl(2,4,6-trimethylbenzoyl)phosphine oxide; 2-hydroxy-2-methylpropiophenone; 2-ethylanthraquinone; 3′-hydroxyacetophenone; 4′-hydroxyacetophenone; 3-hydroxybenzophenone; 4-hydroxybenzophenone; 2-methyl-4′-(methylthio)-2-morpholinopropiophenone; 4′-phenoxyacetophenone; thioxanthen-9-one; ethyl phenyl(2,4,6-trimethylbenzoyl)phosphinate and mixtures thereof; most preferably said initiator is selected from the group consisting of 2,2-dimethoxy-2-phenylacetophenone; 4,4′-bis(diethylamino)benzophenone, 4,4′-bis(dimethylamino)benzophenone; camphorquinone; ethyl phenyl(2,4,6-trimethylbenzoyl)phosphinate and mixtures thereof; and said thermal initiator is selected from the group consisting of 2,3-dimethyl-2,3-diphenylbutane; tert-butyl hydroperoxide; tert-amyl hydroperoxide; cumyl hydroperoxide; 1,1,3,3-tetramethylbutyl hydroperoxide; isopropylcumyl hydroperoxide; isopropylcumyl hydroperoxide; 2,5-dimethyl-2,5-di(tert-butylperoxy)hexyne; 3,6,9-triethyl-3,6,9-trimethyl-1,4,7-triperoxonane; di(tert-butyl)peroxide; 2,5-dimethyl-2,5-di(tert-butylperoxy)hexane; di(tert-butylperoxy-isopropyl)benzene; tert-butyl cumyl peroxide; di-(tert-amyl)-peroxide; dicumyl peroxide; butyl 4,4-di(tert-butylperoxy)valerate; tert-butylperoxybenzoate; 2,2-di(tert-butylperoxy)butane; tert-amyl peroxy-benzoate; tert-butylperoxy-acetate; tert-butylperoxy-(2-ethylhexyl)carbonate; tert-butylperoxy isopropyl carbonate; tert-butyl peroxy-3,5,5-trimethyl-hexanoate; 1,1-di(tert-butylperoxy)cyclohexane; tert-amyl peroxyacetate; tert-amylperoxy-(2-ethylhexyl)carbonate; 1,1-di(tert-butylperoxy)-3,5,5-trimethylcyclohexane; 1,1-di(tert-amylperoxy)cyclohexane; tert-butyl-monoperoxy-maleate; 1,1′-azodi(hexahydrobenzonitrile); tert-butyl peroxy-isobutyrate; tert-butyl peroxydiethylacetate; tert-butyl peroxy-2-ethylhexanoate; dibenzoyl peroxide; tert-amyl peroxy-2-ethylhexanoate; di(4-methylbenzoyl)peroxide; 1,1,3,3-tetramethylbutyl peroxy-2-ethylhexanoate; 2,5-dimethyl-2,5-di(2-ethylhexanoylperoxy)hexane; 2,2′-azodi(2-methylbutyronitrile); 2,2′-azodi(isobutyronitrile); 2,2′-azodi(2,4-dimethylvaleronitrile) didecanoyl peroxide; dilauroyl peroxide; di(3,5,5-trimethylhexanoyl) peroxide; tert-amyl peroxypivalate; tert-butyl peroxyneoheptanoate; 1,1,3,3-tetramethylbutyl peroxypivalate; tert-butyl peroxypivalate; dicetyl peroxydicarbonate; dimyristyl peroxydicarbonate; di(2-ethylhexyl) peroxydicarbonate; di(4-tert-butylcyclohexyl) peroxydicarbonate; diisopropyl peroxydicarbonate; tert-butyl peroxyneodecanoate; di-sec-butyl peroxydicarbonate; tert-amyl peroxyneodecanoate; cumyl peroxyneoheptanoate; di(3-methoxybutyl) peroxydicarbonate; 1,1,3,3-tetramethylbutyl peroxyneodecanoate; cumyl peroxyneodecanoate; diisobutyryl peroxide and mixtures thereof; preferably said initiator is selected from the group consisting of 2,3-dimethyl-2,3-diphenylbutane; 2,5-dimethyl-2,5-di(tert-butylperoxy)hexyne; 3,6,9-triethyl-3,6,9-trimethyl-1,4,7-triperoxonane; di(tert-butyl)peroxide; 2,5-dimethyl-2,5-di(tert-butylperoxy)hexane; di(tert-butylperoxy-isopropyl)benzene; tert-butyl cumyl peroxide; di-(tert-amyl)-peroxide; dicumyl peroxide; butyl 4,4-di(tert-butylperoxy)valerate; 2,2-di(tert-butylperoxy)butane; tert-butylperoxy-acetate; tert-butylperoxy-(2-ethylhexyl)carbonate; tert-butylperoxy isopropyl carbonate; tert-butyl peroxy-3,5,5-trimethyl-hexanoate; 1,1-di(tert-butylperoxy)cyclohexane; tert-amyl peroxyacetate; tert-amylperoxy-(2-ethylhexyl)carbonate; 1,1-di(tert-butylperoxy)-3,5,5-trimethylcyclohexane; 1,1-di(tert-amylperoxy)cyclohexane; tert-butyl-monoperoxy-maleate; tert-butyl peroxy-isobutyrate; tert-butyl peroxydiethylacetate; tert-butyl peroxy-2-ethylhexanoate; tert-amyl peroxy-2-ethylhexanoate; di(4-methylbenzoyl)peroxide; 1,1,3,3-tetramethylbutyl peroxy-2-ethylhexanoate; 2,5-dimethyl-2,5-di(2-ethylhexanoylperoxy)hexane; didecanoyl peroxide; dilauroyl peroxide; di(3,5,5-trimethylhexanoyl) peroxide; tert-amyl peroxypivalate; tert-butyl peroxyneoheptanoate; 1,1,3,3-tetramethylbutyl peroxypivalate; tert-butyl peroxypivalate; dicetyl peroxydicarbonate; dimyristyl peroxydicarbonate; di(2-ethylhexyl) peroxydicarbonate; di(4-tert-butylcyclohexyl) peroxydicarbonate; diisopropyl peroxydicarbonate; tert-butyl peroxyneodecanoate; di-sec-butyl peroxydicarbonate; tert-amyl peroxyneodecanoate; cumyl peroxyneoheptanoate; di(3-methoxybutyl) peroxydicarbonate; 1,1,3,3-tetramethylbutyl peroxyneodecanoate; cumyl peroxyneodecanoate; diisobutyryl peroxide and mixtures thereof; more preferably said thermal initiator is selected from the group consisting of tert-butylperoxy-(2-ethylhexyl)carbonate; tert-butylperoxy isopropyl carbonate; tert-butyl peroxy-3,5,5-trimethyl-hexanoate; 1,1-di(tert-butylperoxy)cyclohexane; tert-amyl peroxyacetate; tert-amylperoxy-(2-ethylhexyl)carbonate; 1,1-di(tert-butylperoxy)-3,5,5-trimethylcyclohexane; 1,1-di(tert-amylperoxy)cyclohexane; tert-butyl-monoperoxy-maleate; tert-butyl peroxy-isobutyrate; tert-butyl peroxydiethylacetate; tert-butyl peroxy-2-ethylhexanoate; tert-amyl peroxy-2-ethylhexanoate; di(4-methylbenzoyl)peroxide; 1,1,3,3-tetramethylbutyl peroxy-2-ethylhexanoate; 2,5-dimethyl-2,5-di(2-ethylhexanoylperoxy)hexane; didecanoyl peroxide; dilauroyl peroxide; di(3,5,5-trimethylhexanoyl) peroxide; tert-amyl peroxypivalate; tert-butyl peroxyneoheptanoate; 1,1,3,3-tetramethylbutyl peroxypivalate; tert-butyl peroxypivalate; dicetyl peroxydicarbonate; dimyristyl peroxydicarbonate; di(2-ethylhexyl) peroxydicarbonate; di(4-tert-butylcyclohexyl) peroxydicarbonate; diisopropyl peroxydicarbonate; tert-butyl peroxyneodecanoate; di-sec-butyl peroxydicarbonate; tert-amyl peroxyneodecanoate; cumyl peroxyneoheptanoate; di(3-methoxybutyl) peroxydicarbonate; 1,1,3,3-tetramethylbutyl peroxyneodecanoate; cumyl peroxyneodecanoate; diisobutyryl peroxide; 2,2′-azodi(isobutyronitrile); 2,2′-azodi(2,4-dimethylvaleronitrile) and mixtures thereof, most preferably said initiator is selected from the group consisting of tert-butylperoxy-(2-ethylhexyl)carbonate; 2,2′-azodi(isobutyronitrile); 2,2′-azodi(2,4-dimethylvaleronitrile) and mixtures thereof;
with the proviso that when said thiourea terminated polymer only has Structure 1 of claim 1 said multifunctional thiol crosslinker has an average thiol functionality of greater than 2.

3. The resin of claim 2, said resin comprising:
a) an inhibitor selected from the group consisting of phenothiazine, quinone monomethyl ether, butylated hydroxytoluene, hydroquinone, avobenzone, 2-nitrophenyl phenyl sulfide, 2-(2′-Hydroxy-3′,5′-di-tert-butyl-phenyl)-5-chlorobenzo-triazole, 2,2′-(2,5-thiophenediyl)bis(5-tert-butylbenzoxazole), Acid Orange 5, Acid Orange 7, Acid Orange 19 Acid Orange 20, Acid Red 13, Acid Red 88, Alcian Yellow, Alizarine Yellow R, Allura Red AC, Amaranth (dye), Amido Black 10B, Aniline Yellow, Azo Violet, Azorubine, Basic Red 18, Biebrich Scarlet, Bismarck Brown Y, Black 7984, Brilliant Black BN, Brown FK, Brown HT, Calconcarboxylic acid, Chrysoine resorcinol, Citrus Red 2, Congo Red, D&C Red 33, Direct Blue 1, Direct Blue 15, Disperse Orange 1, Eriochrome Black T, Evans Blue, Fast Yellow AB, Hydroxynaphthol Blue, Janus Green B, Lithol Rubine BK, Metanil Yellow, Methyl Orange, Methyl Red, Methyl Yellow, Mordant Brown 33, Mordant Red 19, Naphthol AS, Oil Red 0, Orange B, Orange G, Orange GGN, Para Red, Pigment Yellow 10, Ponceau 2R, Ponceau 3R, Ponceau 4R, Ponceau 6R, Ponceau S, Prontosil, Red 2G, Scarlet GN, Sirius Red, Solvent Black 3, Solvent Red 26, Solvent Yellow 56, Solvent Yellow 124, Sudan I, Sudan II, Sudan III, Sudan IV, Sudan Red 7B, Sudan Red G, Sudan Yellow 3G, Sunset Yellow FCF, Tartrazine, Tropaeolin, Trypan Blue, Yellow 2G and mixtures thereof; preferably said inhibitor is selected from the group consisting of Aniline Yellow, Azo Violet, Calconcarboxylic acid, Citrus Red 2, Disperse Orange 1, Janus Green B, Methyl Red, Methyl Yellow, Naphthol AS, Oil Red 0, Para Red, Solvent Black 3, Solvent Red 26, Solvent Yellow 56, Solvent Yellow 124, Sudan I, Sudan II, Sudan III, Sudan IV, Sudan Red 7B, Sudan Red G, Sudan Yellow 3G, 2,2′-(2,5-thiophenediyl)bis(5-tert-butyl benzoxazole) and mixtures thereof; more preferably said inhibitor is selected from the group consisting of Aniline Yellow, Azo Violet, Citrus Red 2, Disperse Orange 1, Methyl Yellow, Naphthol AS, Oil Red 0, Para Red, Solvent Black 3, Solvent Red 26, Solvent Yellow 56, Solvent Yellow 124, Sudan I, Sudan II, Sudan III, Sudan IV, Sudan Red 7B, Sudan Red G, Sudan Yellow 3G, 2,2′-(2,5-thiophenediyl)bis(5-tert-butyl benzoxazole) and mixtures thereof; most preferably said inhibitor is selected from the group consisting of Oil Red 0, Sudan I, Sudan II, Sudan III, Sudan IV, 2,2′-(2,5-thiophenediyl)bis(5-tert-butyl benzoxazole) and mixtures thereof, and/or
b) an adjunct selected from the group consisting of acetamide, acetyltributylcitrate, benzyl benzoate, benzyl butyl phthalate, bis(2-ethylhexyl) adipate, bis(2-ethylhexyl) phthalate, centralite, 1,2-cyclohexane dicarboxylic acid diisononyl ester, dibutyl phthalate, dibutyl sebacate, diethylene glycol dinitrate, diisobutyl phthalate, diisodecyl phthalate, diisononyl phthalate, dimethyl adipate, dimethyl methylphosphonate, 2,4-dinitrotoluene, dioctyl adipate, dioctyl sebacate, dioctyl terephthalate, dipropylene glycol, biobased oils, epoxidized soybean oil, fatty acids (stearic, lauryl, linoleic, oleic), soybean oil, ethyl butyrate, ethylene carbonate, furoin, linseed oil, maleic acid dibutyl ester, naphtha, neopentyl glycol, triethylene glycol, paraffin, polybutene, polychlorinated biphenyl, polychlorinated terphenyl, propylene carbonate, tris(1-(2-methyl))aziridinyl phosphine oxide, trimesoyl-1-(2-ethyl)aziridine, tetraethylenepentamine acrylonitrile glycidol adduct, partially cyanoacrylated tetraethylenepentamine, isophthaloyl-bis(methyl-ethyleneimide), triacetin, tributyl phosphate, tricresyl phosphate, triethyl phosphate, triethylene glycol dinitrate, trimethylolethane trinitrate, metal oxides (alumina, iron oxide, titanium dioxide, zirconium oxide, zinc oxide), talc, glass (both fibers and beads), metal carbonates (including magnesium and calcium), salts (nitrates, perchlorates, sulfates), metals (magnesium, aluminum, iron, silver, copper, gold), carbon black, carbon nanotubes, graphene, graphene oxide, clays, cellulose, nanocellulose, precipitated silica, fumed silica, polyhedral oligomeric silsesquioxane, and mixtures thereof, preferably said one or more entrained adjuncts being selected from the group consisting of acetyltributylcitrate, benzyl benzoate, benzyl butyl phthalate, bis(2-ethylhexyl) adipate, bis(2-ethylhexyl) phthalate, centralite, 1,2-cyclohexane dicarboxylic acid diisononyl ester, dibutyl phthalate, dibutyl sebacate, diethylene glycol dinitrate, diisobutyl phthalate, diisodecyl phthalate, diisononyl phthalate, dimethyl adipate, dimethyl methylphosphonate, 2,4-dinitrotoluene, dioctyl adipate, dioctyl sebacate, dioctyl terephthalate, dipropylene glycol, biobased oils, ethyl butyrate, ethylene carbonate, furoin, maleic acid dibutyl ester, neopentyl glycol, triethylene glycol, polybutene, propylene carbonate, triacetin, tributyl phosphate, tricresyl phosphate, triethyl phosphate, triethylene glycol dinitrate, trimethylolethane trinitrate, metal oxides, metal carbonates, salts, metals, carbon black, clays, cellulose, nanocellulose, precipitated silica, fumed silica, and mixtures thereof, more preferably said one or more entrained adjuncts being selected from the group consisting of bis(2-ethylhexyl) adipate, bis(2-ethylhexyl) phthalate, dibutyl phthalate, dibutyl sebacate, diisobutyl phthalate, diisodecyl phthalate, diisononyl phthalate, dimethyl adipate, dioctyl adipate, dioctyl sebacate, dioctyl terephthalate, dipropylene glycol, ethyl butyrate, ethylene carbonate, furoin, maleic acid dibutyl ester, neopentyl glycol, triethylene glycol, polybutene, propylene carbonate, metal oxides, salts, metals, carbon black, cellulose, nanocellulose, fumed silica, and mixtures thereof, most preferably said one or more entrained adjuncts being selected from the group consisting of bis(2-ethylhexyl) adipate, dibutyl sebacate, dimethyl adipate, dioctyl adipate, dioctyl sebacate, triethylene glycol, fumed silica, metals, salts, and mixtures thereof.

4. The resin of claim 3 having:
a) a ratio of thiourea terminated polymer allyl groups to multifunctional thiol crosslinker thiol groups of about 0.8:1 to about 1.2:1, preferably said resin having a ratio of thiourea terminated polymer allyl groups to multifunctional thiol crosslinker thiol groups of about 0.9:1 to about 1.1:1, more preferably said resin having a ratio of thiourea terminated polymer allyl groups to multifunctional thiol crosslinker thiol groups of about 0.95:1 to about 1.05:1; most preferably said resin having a ratio of thiourea terminated polymer allyl groups to multifunctional thiol crosslinker thiol groups of about 1:1; and
b) said radical initiator is present in said composition, based on total composition weight at a level of from about 0.25 wt. % to about 15 wt. %; preferably said radical initiator is present in said composition, based on total composition weight at a level of from about 0.5 wt. % to about 10 wt. %; more preferably said radical initiator is present in said composition, based on total composition weight at a level of from about 0.75 wt. % to about 7.5 wt. %; most preferably said radical initiator is present in said composition, based on total composition weight at a level of from about 1 wt. % to about 5 wt. %. When said resin is used in a casting process a UV and/or thermal initiator may be used, when said resin is used in a vat photopolymerization process a UV initiator along with an optional thermal initiator should be used in said resin, and when the resin is used in a direct ink write process a UV initiator along with a thermal initiator and a solid adjunct is required. The solid adjunct is employed so the art made from the resin will keep its shape during printing.
c) said optional inhibitor is present in said composition, based on total composition weight at a level of from about 0.01 wt. % to about 5 wt. %, preferably said optional inhibitor is present in said composition, based on total composition weight at a level of from about 0.02 wt. % to about 0.5 wt. %.
d) said optional adjunct is present in said composition, based on total composition weight at a level of from about 0 wt. % to about 99 wt. %; preferably said one or more entrained adjuncts is present, based on said article mass percent, at a level of from about 5 wt. % to about 93 wt. %; more preferably said one or more entrained adjuncts is present, based on said article mass percent, at a level of from about 10 wt. % to about 91 wt. %; most preferably said one or more entrained adjuncts is present, based on said article mass percent, at a level of from about 15 wt. % to about 90 wt. %.

5. A process of making a resin said process comprising combining:
a) a thiourea terminated polymer according to Structure 1 and/or Structure 2 of claim 1;
b) a multifunctional thiol crosslinker, preferably said multifunctional thiol crosslinker is selected from the group consisting of 1,4-butanedithiol; 4,5-bis(mercaptomethyl)-o-xylene; 1,4-benzenedithiol; 4,4′-biphenyldithiol; 1,3,5-benzenetrithiol; 2,3-butanedithiol; 1,3-benzenedithiol; 1,10-decanedithiol; DL-dithiothreitol; dithioerythritol; 1,5-dimercaptonaphthalene; 3,6-dioxa-1,8-octanedithiol; 3,7-dithia-1,9-nonanedithiol; 1,2-ethanedithiol; 1,6-hexanedithiol; bis(2-mercaptoethyl) sulfide; 1,8-octanedithiol; 1,9-nonanedithiol 1,3-propanedithiol; 1,5-pentanedithiol; 4,4′-thiobisbenzenethiol; tetra(ethylene glycol) dithiol; 1,11-undecanedithiol; hexa(ethylene glycol) dithiol; 1,16-hexadecanedithiol; a thiol-functional polymer; ethylene bis(thioglycolate); trimethylolpropane tris(thioglycolate); ethylene glycol bis(3-mercaptopropionate); trimethylolpropane tris(3-mercaptopropionate); pentaerythritol tetrakis(3-mercaptopropionate); pentaerythritol tetrakis(mercaptoacetate) and mixtures thereof; more preferably said multifunctional thiol crosslinker is selected from the group consisting of trimethylolpropane tris(3-mercaptopropionate); pentaerythritol tetrakis(3-mercaptopropionate); ethylene glycol bis(3-mercaptopropionate); 3,6-dioxa-1,8-octanedithiol and mixtures thereof, and
c) a radical initiator, preferably said radical initiator is a UV initiator and/or thermal initiator, preferably said UV initiator is selected from the group consisting of acetophenone; anisoin; anthraquinone; (benzene)tricarbonylchromium; benzil; benzoin; benzoin ethyl ether; benzoin isobutyl ether; benzoin methyl ether; benzophenone; 1-hydroxycyclohexyl phenyl ketone; 3,3′,4,4′-benzophenonetetracarboxylic dianhydride; 4-benzoylbiphenyl; 2-benzyl-2-(dimethylamino)-4′-morpholinobutyrophenone; 4,4′-bis(diethylamino)benzophenone; 4,4′-bis(dimethylamino)benzophenone; camphorquinone; 2-chlorothioxanthen-9-one; (cumene)cyclopentadienyliron(II) hexafluorophosphate; dibenzosuberenone; 2,2-diethoxyacetophenone; 4,4′-dihydroxybenzophenone; 2,2-dimethoxy-2-phenylacetophenone; 4-(dimethylamino)benzophenone; 4,4′-dimethylbenzil; 2,5-dimethylbenzophenone; 3,4-dimethylbenzophenone; diphenyl(2,4,6-trimethylbenzoyl)phosphine oxide; 2-hydroxy-2-methylpropiophenone; 4′-ethoxyacetophenone; 2-ethylanthraquinone; ferrocene; 3′-hydroxyacetophenone; 4′-hydroxyacetophenone; 3-hydroxybenzophenone; 4-hydroxybenzophenone; 1-hydroxycyclohexyl phenyl ketone; 2-hydroxy-2-methylpropiophenone; 2-methylbenzophenone; 3-methylbenzophenone; methylbenzoylformate; 2-methyl-4′-(methylthio)-2-morpholinopropiophenone; phenanthrenequinone; 4′-phenoxyacetophenone; thioxanthen-9-one; ethyl phenyl(2,4,6-trimethylbenzoyl)phosphinate and mixtures thereof; preferably said UV initiator is selected from the group consisting of acetophenone; anisoin; anthraquinone; (benzene)tricarbonylchromium; benzil; benzoin; benzoin ethyl ether; benzoin isobutyl ether; benzoin methyl ether; benzophenone; 1-hydroxycyclohexyl phenyl ketone; 4-benzoylbiphenyl; 2-benzyl-2-(dimethylamino)-4′-morpholinobutyrophenone; 4,4′-bis(diethylamino)benzophenone; 4,4′-bis(dimethylamino)benzophenone; camphorquinone; 2-chlorothioxanthen-9-one; dibenzosuberenone; 2,2-diethoxyacetophenone; 4,4′-dihydroxybenzophenone; 2,2-dimethoxy-2-phenylacetophenone, 4-(dimethylamino)benzophenone, 4,4′-dimethylbenzil, 2,5-dimethylbenzophenone; 3,4-dimethylbenzophenone; diphenyl(2,4,6-trimethylbenzoyl)phosphine oxide; 2-hydroxy-2-methylpropiophenone; 4′-ethoxyacetophenone; 2-ethylanthraquinone; 3′-hydroxyacetophenone; 4′-hydroxyacetophenone; 3-hydroxybenzophenone; 4-hydroxybenzophenone; 1-hydroxycyclohexyl phenyl ketone; 2-hydroxy-2-methylpropiophenone; 2-methylbenzophenone; 3-methylbenzophenone; methylbenzoylformate; 2-methyl-4′-(methylthio)-2-morpholinopropiophenone; 4′-phenoxyacetophenone; thioxanthen-9-one; ethyl phenyl(2,4,6-trimethylbenzoyl)phosphinate and mixtures thereof; more preferably said UV initiator is selected from the group consisting of acetophenone; anisoin; anthraquinone; (benzene)tricarbonylchromium; benzoin ethyl ether; benzoin isobutyl ether; benzoin methyl ether; 4-benzoylbiphenyl; 2-benzyl-2-(dimethylamino)-4′-morpholinobutyrophenone; 4,4′-bis(diethylamino)benzophenone; 4,4′-bis(dimethylamino)benzophenone; camphorquinone; 2-chlorothioxanthen-9-one; dibenzosuberenone; 2,2-diethoxyacetophenone; 4,4′-dihydroxybenzophenone; 2,2-dimethoxy-2-phenylacetophenone; 4-(dimethylamino)benzophenone; 3,4-dimethylbenzophenone; diphenyl(2,4,6-trimethylbenzoyl)phosphine oxide; 2-hydroxy-2-methylpropiophenone; 2-ethylanthraquinone; 3′-hydroxyacetophenone; 4′-hydroxyacetophenone; 3-hydroxybenzophenone; 4-hydroxybenzophenone; 2-methyl-4′-(methylthio)-2-morpholinopropiophenone; 4′-phenoxyacetophenone; thioxanthen-9-one; ethyl phenyl(2,4,6-trimethylbenzoyl)phosphinate and mixtures thereof; most preferably said initiator is selected from the group consisting of 2,2-dimethoxy-2-phenylacetophenone; 4,4′-bis(diethylamino)benzophenone, 4,4′-bis(dimethylamino)benzophenone; camphorquinone; ethyl phenyl(2,4,6-trimethylbenzoyl)phosphinate and mixtures thereof; and said thermal initiator is selected from the group consisting of 2,3-dimethyl-2,3-diphenylbutane; tert-butyl hydroperoxide; tert-amyl hydroperoxide; cumyl hydroperoxide; 1,1,3,3-tetramethylbutyl hydroperoxide; isopropylcumyl hydroperoxide; isopropylcumyl hydroperoxide; 2,5-dimethyl-2,5-di(tert-butylperoxy)hexyne; 3,6,9-triethyl-3,6,9-trimethyl-1,4,7-triperoxonane; di(tert-butyl)peroxide; 2,5-dimethyl-2,5-di(tert-butylperoxy)hexane; di(tert-butylperoxy-isopropyl)benzene; tert-butyl cumyl peroxide; di-(tert-amyl)-peroxide; dicumyl peroxide; butyl 4,4-di(tert-butylperoxy)valerate; tert-butylperoxybenzoate; 2,2-di(tert-butylperoxy)butane; tert-amyl peroxy-benzoate; tert-butylperoxy-acetate; tert-butylperoxy-(2-ethylhexyl)carbonate; tert-butylperoxy isopropyl carbonate; tert-butyl peroxy-3,5,5-trimethyl-hexanoate; 1,1-di(tert-butylperoxy)cyclohexane; tert-amyl peroxyacetate; tert-amylperoxy-(2-ethylhexyl)carbonate; 1,1-di(tert-butylperoxy)-3,5,5-trimethylcyclohexane; 1,1-di(tert-amylperoxy)cyclohexane; tert-butyl-monoperoxy-maleate; 1,1′-azodi(hexahydrobenzonitrile); tert-butyl peroxy-isobutyrate; tert-butyl peroxydiethylacetate; tert-butyl peroxy-2-ethylhexanoate; dibenzoyl peroxide; tert-amyl peroxy-2-ethylhexanoate; di(4-methylbenzoyl)peroxide; 1,1,3,3-tetramethylbutyl peroxy-2-ethylhexanoate; 2,5-dimethyl-2,5-di(2-ethylhexanoylperoxy)hexane; 2,2′-azodi(2-methylbutyronitrile); 2,2′-azodi(isobutyronitrile); 2,2′-azodi(2,4-dimethylvaleronitrile) didecanoyl peroxide; dilauroyl peroxide; di(3,5,5-trimethylhexanoyl) peroxide; tert-amyl peroxypivalate; tert-butyl peroxyneoheptanoate; 1,1,3,3-tetramethylbutyl peroxypivalate; tert-butyl peroxypivalate; dicetyl peroxydicarbonate; dimyristyl peroxydicarbonate; di(2-ethylhexyl) peroxydicarbonate; di(4-tert-butylcyclohexyl) peroxydicarbonate; diisopropyl peroxydicarbonate; tert-butyl peroxyneodecanoate; di-sec-butyl peroxydicarbonate; tert-amyl peroxyneodecanoate; cumyl peroxyneoheptanoate; di(3-methoxybutyl) peroxydicarbonate; 1,1,3,3-tetramethylbutyl peroxyneodecanoate; cumyl peroxyneodecanoate; diisobutyryl peroxide and mixtures thereof; preferably said initiator is selected from the group consisting of 2,3-dimethyl-2,3-diphenylbutane; 2,5-dimethyl-2,5-di(tert-butylperoxy)hexyne; 3,6,9-triethyl-3,6,9-trimethyl-1,4,7-triperoxonane; di(tert-butyl)peroxide; 2,5-dimethyl-2,5-di(tert-butylperoxy)hexane; di(tert-butylperoxy-isopropyl)benzene; tert-butyl cumyl peroxide; di-(tert-amyl)-peroxide; dicumyl peroxide; butyl 4,4-di(tert-butylperoxy)valerate; 2,2-di(tert-butylperoxy)butane; tert-butylperoxy-acetate; tert-butylperoxy-(2-ethylhexyl)carbonate; tert-butylperoxy isopropyl carbonate; tert-butyl peroxy-3,5,5-trimethyl-hexanoate; 1,1-di(tert-butylperoxy)cyclohexane; tert-amyl peroxyacetate; tert-amylperoxy-(2-ethylhexyl)carbonate; 1,1-di(tert-butylperoxy)-3,5,5-trimethylcyclohexane; 1,1-di(tert-amylperoxy)cyclohexane; tert-butyl-monoperoxy-maleate; tert-butyl peroxy-isobutyrate; tert-butyl peroxydiethylacetate; tert-butyl peroxy-2-ethylhexanoate; tert-amyl peroxy-2-ethylhexanoate; di(4-methylbenzoyl)peroxide; 1,1,3,3-tetramethylbutyl peroxy-2-ethylhexanoate; 2,5-dimethyl-2,5-di(2-ethylhexanoylperoxy)hexane; didecanoyl peroxide; dilauroyl peroxide; di(3,5,5-trimethylhexanoyl) peroxide; tert-amyl peroxypivalate; tert-butyl peroxyneoheptanoate; 1,1,3,3-tetramethylbutyl peroxypivalate; tert-butyl peroxypivalate; dicetyl peroxydicarbonate; dimyristyl peroxydicarbonate; di(2-ethylhexyl) peroxydicarbonate; di(4-tert-butylcyclohexyl) peroxydicarbonate; diisopropyl peroxydicarbonate; tert-butyl peroxyneodecanoate; di-sec-butyl peroxydicarbonate; tert-amyl peroxyneodecanoate; cumyl peroxyneoheptanoate; di(3-methoxybutyl) peroxydicarbonate; 1,1,3,3-tetramethylbutyl peroxyneodecanoate; cumyl peroxyneodecanoate; diisobutyryl peroxide and mixtures thereof; more preferably said thermal initiator is selected from the group consisting of tert-butylperoxy-(2-ethylhexyl)carbonate; tert-butylperoxy isopropyl carbonate; tert-butyl peroxy-3,5,5-trimethyl-hexanoate; 1,1-di(tert-butylperoxy)cyclohexane; tert-amyl peroxyacetate; tert-amylperoxy-(2-ethylhexyl)carbonate; 1,1-di(tert-butylperoxy)-3,5,5-trimethylcyclohexane; 1,1-di(tert-amylperoxy)cyclohexane; tert-butyl-monoperoxy-maleate; tert-butyl peroxy-isobutyrate; tert-butyl peroxydiethylacetate; tert-butyl peroxy-2-ethylhexanoate; tert-amyl peroxy-2-ethylhexanoate; di(4-methylbenzoyl)peroxide; 1,1,3,3-tetramethylbutyl peroxy-2-ethylhexanoate; 2,5-dimethyl-2,5-di(2-ethylhexanoylperoxy)hexane; didecanoyl peroxide; dilauroyl peroxide; di(3,5,5-trimethylhexanoyl) peroxide; tert-amyl peroxypivalate; tert-butyl peroxyneoheptanoate; 1,1,3,3-tetramethylbutyl peroxypivalate; tert-butyl peroxypivalate; dicetyl peroxydicarbonate; dimyristyl peroxydicarbonate; di(2-ethylhexyl) peroxydicarbonate; di(4-tert-butylcyclohexyl) peroxydicarbonate; diisopropyl peroxydicarbonate; tert-butyl peroxyneodecanoate; di-sec-butyl peroxydicarbonate; tert-amyl peroxyneodecanoate; cumyl peroxyneoheptanoate; di(3-methoxybutyl) peroxydicarbonate; 1,1,3,3-tetramethylbutyl peroxyneodecanoate; cumyl peroxyneodecanoate; diisobutyryl peroxide; 2,2′-azodi(isobutyronitrile); 2,2′-azodi(2,4-dimethylvaleronitrile) and mixtures thereof, most preferably said initiator is selected from the group consisting of tert-butylperoxy-(2-ethylhexyl)carbonate; 2,2′-azodi(isobutyronitrile); 2,2′-azodi(2,4-dimethylvaleronitrile) and mixtures thereof; and to form a mixture, preferably said mixture is homogenous; and
d) an optional inhibitor an inhibitor selected from the group consisting of phenothiazine, quinone monomethyl ether, butylated hydroxytoluene, hydroquinone, avobenzone, 2-nitrophenyl phenyl sulfide, 2-(2′-Hydroxy-3′,5′-di-tert-butyl-phenyl)-5-chlorobenzo-triazole, 2,2′-(2,5-thiophenediyl)bis(5-tert-butylbenzoxazole), Acid Orange 5, Acid Orange 7, Acid Orange 19 Acid Orange 20, Acid Red 13, Acid Red 88, Alcian Yellow, Alizarine Yellow R, Allura Red AC, Amaranth (dye), Amido Black 10B, Aniline Yellow, Azo Violet, Azorubine, Basic Red 18, Biebrich scarlet, Bismarck Brown Y, Black 7984, Brilliant Black BN, Brown FK, Brown HT, Calconcarboxylic acid, Chrysoine resorcinol, Citrus Red 2, Congo Red, D&C Red 33, Direct Blue 1, Direct Blue 15, Disperse Orange 1, Eriochrome Black T, Evans Blue, Fast Yellow AB, Hydroxynaphthol Blue, Janus Green B, Lithol Rubine BK, Metanil Yellow, Methyl Orange, Methyl Red, Methyl Yellow, Mordant Brown 33, Mordant Red 19, Naphthol AS, Oil Red 0, Orange B, Orange G, Orange GGN, Para Red, Pigment Yellow 10, Ponceau 2R, Ponceau 3R, Ponceau 4R, Ponceau 6R, Ponceau S, Prontosil, Red 2G, Scarlet GN, Sirius Red, Solvent Black 3, Solvent Red 26, Solvent Yellow 56, Solvent Yellow 124, Sudan I, Sudan II, Sudan III, Sudan IV, Sudan Red 7B, Sudan Red G, Sudan Yellow 3G, Sunset Yellow FCF, Tartrazine, Tropaeolin, Trypan Blue, Yellow 2G and mixtures thereof, preferably said inhibitor is selected from the group consisting of Aniline Yellow, Azo Violet, Calconcarboxylic acid, Citrus Red 2, Disperse Orange 1, Janus Green B, Methyl Red, Methyl Yellow, Naphthol AS, Oil Red 0, Para Red, Solvent Black 3, Solvent Red 26, Solvent Yellow 56, Solvent Yellow 124, Sudan I, Sudan II, Sudan III, Sudan IV, Sudan Red 7B, Sudan Red G, Sudan Yellow 3G, 2,2′-(2,5-thiophenediyl)bis(5-tert-butyl benzoxazole) and mixtures thereof; more preferably said inhibitor is selected from the group consisting of Aniline Yellow, Azo Violet, Citrus Red 2, Disperse Orange 1, Methyl Yellow, Naphthol AS, Oil Red 0, Para Red, Solvent Black 3, Solvent Red 26, Solvent Yellow 56, Solvent Yellow 124, Sudan I, Sudan II, Sudan III, Sudan IV, Sudan Red 7B, Sudan Red G, Sudan Yellow 3G, 2,2′-(2,5-thiophenediyl)bis(5-tert-butyl benzoxazole) and mixtures thereof; most preferably said inhibitor is selected from the group consisting of Oil Red 0, Sudan I, Sudan II, Sudan III, Sudan IV, 2,2′-(2,5-thiophenediyl)bis(5-tert-butyl benzoxazole) and mixtures thereof; and/or
e) an optional adjunct selected from the group consisting of acetamide, acetyltributylcitrate, benzyl benzoate, benzyl butyl phthalate, bis(2-ethylhexyl) adipate, bis(2-ethylhexyl) phthalate, centralite, 1,2-cyclohexane dicarboxylic acid diisononyl ester, dibutyl phthalate, dibutyl sebacate, diethylene glycol dinitrate, diisobutyl phthalate, diisodecyl phthalate, diisononyl phthalate, dimethyl adipate, dimethyl methylphosphonate, 2,4-dinitrotoluene, dioctyl adipate, dioctyl sebacate, dioctyl terephthalate, dipropylene glycol, biobased oils, epoxidized soybean oil, fatty acids (stearic, lauryl, linoleic, oleic), soybean oil, ethyl butyrate, ethylene carbonate, furoin, linseed oil, maleic acid dibutyl ester, naphtha, neopentyl glycol, triethylene glycol, paraffin, polybutene, polychlorinated biphenyl, polychlorinated terphenyl, propylene carbonate, tris(1-(2-methyl))aziridinyl phosphine oxide, trimesoyl-1-(2-ethyl)aziridine, tetraethylenepentamine acrylonitrile glycidol adduct, partially cyanoacrylated tetraethylenepentamine, isophthaloyl-bis(methyl-ethyleneimide), triacetin, tributyl phosphate, tricresyl phosphate, triethyl phosphate, triethylene glycol dinitrate, trimethylolethane trinitrate, metal oxides (alumina, iron oxide, titanium dioxide, zirconium oxide, zinc oxide), talc, glass (both fibers and beads), metal carbonates (including magnesium and calcium), salts (nitrates, perchlorates, sulfates), metals (magnesium, aluminum, iron, silver, copper, gold), carbon black, carbon nanotubes, graphene, graphene oxide, clays, cellulose, nanocellulose, precipitated silica, fumed silica, polyhedral oligomeric silsesquioxane, and mixtures thereof, preferably said one or more entrained adjuncts being selected from the group consisting of acetyltributylcitrate, benzyl benzoate, benzyl butyl phthalate, bis(2-ethylhexyl) adipate, bis(2-ethylhexyl) phthalate, centralite, 1,2-cyclohexane dicarboxylic acid diisononyl ester, dibutyl phthalate, dibutyl sebacate, diethylene glycol dinitrate, diisobutyl phthalate, diisodecyl phthalate, diisononyl phthalate, dimethyl adipate, dimethyl methylphosphonate, 2,4-dinitrotoluene, dioctyl adipate, dioctyl sebacate, dioctyl terephthalate, dipropylene glycol, biobased oils, ethyl butyrate, ethylene carbonate, furoin, maleic acid dibutyl ester, neopentyl glycol, triethylene glycol, polybutene, propylene carbonate, triacetin, tributyl phosphate, tricresyl phosphate, triethyl phosphate, triethylene glycol dinitrate, trimethylolethane trinitrate, metal oxides, metal carbonates, salts, metals, carbon black, clays, cellulose, nanocellulose, precipitated silica, fumed silica, and mixtures thereof, more preferably said one or more entrained adjuncts being selected from the group consisting of bis(2-ethylhexyl) adipate, bis(2-ethylhexyl) phthalate, dibutyl phthalate, dibutyl sebacate, diisobutyl phthalate, diisodecyl phthalate, diisononyl phthalate, dimethyl adipate, dioctyl adipate, dioctyl sebacate, dioctyl terephthalate, dipropylene glycol, ethyl butyrate, ethylene carbonate, furoin, maleic acid dibutyl ester, neopentyl glycol, triethylene glycol, polybutene, propylene carbonate, metal oxides, salts, metals, carbon black, cellulose, nanocellulose, fumed silica, and mixtures thereof, most preferably said one or more entrained adjuncts being selected from the group consisting of bis(2-ethylhexyl) adipate, dibutyl sebacate, dimethyl adipate, dioctyl adipate, dioctyl sebacate, triethylene glycol, fumed silica, metals, salts, and mixtures thereof. In one aspect, said mixture is formed by dissolving any solid components in any liquid components, preferably while said dissolving step is being conducted.

6. The process of claim 5, wherein:
a) said mixture has a ratio of thiourea terminated polymer allyl groups to multifunctional thiol crosslinker thiol groups of about 0.8:1 to about 1.2:1, preferably said resin having a ratio of thiourea terminated polymer allyl groups to multifunctional thiol crosslinker thiol groups of about 0.9:1 to about 1.1:1, more preferably said resin having a ratio of thiourea terminated polymer allyl groups to multifunctional thiol crosslinker thiol groups of about 0.95:1 to about 1.05:1; most preferably said resin having a ratio of thiourea terminated polymer allyl groups to multifunctional thiol crosslinker thiol groups of about 1:1;
b) said radical initiator is present in said mixture, based on total mixture weight at a level of from about 0.25 wt. % to about 15 wt. %; preferably said radical initiator is present in said mixture, based on total mixture weight at a level of from about 0.5 wt. % to about 10 wt. %; more preferably said radical initiator is present in said composition, based on total composition weight at a level of from about 0.75 wt. % to about 7.5 wt. %; most preferably said radical initiator is present in said composition, based on total composition weight at a level of from about 1 wt. % to about 5 wt. %;
c) said optional inhibitor is present in said composition, based on total composition weight at a level of from about 0.01 wt. % to about 5 wt. %, preferably said optional inhibitor is present in said composition, based on total composition weight at a level of from about 0.02 wt. % to about 0.5 wt. %; and
d) said optional adjunct is present in said composition, based on total composition weight at a level of from about 0 wt. % to about 99 wt. %; preferably said one or more entrained adjuncts is present, based on said article mass percent, at a level of from about 5 wt. % to about 93 wt. %; more preferably said one or more entrained adjuncts is present, based on said article mass percent, at a level of from about 10 wt. % to about 91 wt. %; most preferably said one or more entrained adjuncts is present, based on said article mass percent, at a level of from about 15 wt. % to about 90 wt. %.

7. A method of making an article comprising a thiourea polymer network, said method comprising 3D printing or casting a resin according claim 2, preferably said method comprises casting, direct ink writing, and/or VP 3D printing said resin.

8. The method of claim 7 comprising post thermal curing said article, preferably said thermally post curing comprises heating the green article in an oven between 40° C. and 150° C. for between 1 minute and 1 week; more preferably said thermally post curing comprises heating the green article in an oven between 50° C. and 120° C. for between 15 minutes and 24 hours, most preferably said thermally post curing comprises heating the green article in an oven between 60° C. and 100° C. for between 1 hour and 4 hours.

9. The method of claim 8 comprising direct ink writing and wherein said resin comprises a UV initiator, an optional thermal initiator and a solid adjunct, preferably said resin comprises a UV initiator, a thermal initiator and a solid adjunct, more preferably said resin comprises, based on total article weight percent of from about 1 wt. % to 30 wt. % of a solid adjunct selected from the group consisting of fumed silica, nanocellulose, clay, carbon black, and mixtures thereof, more preferably said composition comprises about 3 wt. % to 25 wt. % of a solid adjunct selected from the group consisting of fumed silica, nanocellulose, clay, carbon black and mixtures thereof; more preferably said composition comprises about 5 wt. % to 15 wt. % of a solid adjunct selected from the group consisting of fumed silica, nanocellulose, clay, carbon black and mixtures thereof, most preferably said composition comprises 8 wt. % to 12 wt. % of a solid adjunct selected from the group consisting of fumed silica, nanocellulose, clay, carbon black and mixtures thereof.
